(19) United States
(12) Patent Application Publication
(10) Pub. No.: US 2011/0292810 A1
(43) Pub. Date: Dec. 1, 2011

(54) APPARATUS AND METHOD FOR TRANSMITTING/RECEIVING DATA IN A COMMUNICATION SYSTEM

(75) Inventors: You-Seok LEE, Daejeon (KR); Sung-Ik PARK, Daejeon (KR); Jae-Hyun SEO, Daejeon (KR); Heung-Mook KIM, Daejeon (KR)

(73) Assignee: Electronics and Telecommunications Research Institute, Daejeon (KR)

(21) Appl. No.: 13/115,238

(22) Filed: May 25, 2011

(30) Foreign Application Priority Data
May 26, 2010 (KR) 10-2010-0049138

(51) Int. Cl. H04W 4/00; H04W 24/00

(52) U.S. Cl. 370/241; 370/310; 370/259

(57) ABSTRACT

A data transmission apparatus of a communication system includes a main data generator configured to generate main data corresponding to a main broadcasting service of broadcasting services; a main signal generator configured to generate a main signal of the main data; an additional data generator configured to generate a plurality of additional data corresponding to various additional services of the broadcasting services; an additional signal generator configured to generate a plurality of additional signals of the plurality of additional data; a power controller configured to control average power of the plurality of additional signals; a coupler configured to couple the main signal and the plurality of additional signals controlled in the average power thereof, and generate a broadcasting signal; and a transmitter configured to transmit the broadcasting signal.

### CROSS-REFERENCE TO RELATED APPLICATIONS

The present application claims priority of Korean Patent Application No. 10-2010-0049138 filed on May 26, 2010, which is incorporated herein by reference in its entirety.

### BACKGROUND OF THE INVENTION

1. Field of the Invention

Exemplary embodiments of the present invention relate to a communication system, and, more particularly, to an apparatus and a method for simultaneously transmitting and receiving a plurality of additional data for broadcasting data in a digital broadcasting system.

2. Description of Related Art

These days, in a communication system, research has been actively conducted to develop a technology capable of providing services having various qualities of services (QoS) to users at a high transmission rate. In a digital broadcasting system as an example of the communication system, methods for transmitting various types of video and audio data and the likes at a high speed through limited resources have been proposed. In other words, in the digital broadcasting system, various methods for improving the transmission efficiency of broadcasting data including various types of video and audio data and the likes have been proposed.

Also, in the digital broadcasting system, in order to provide various types of high definition digital broadcasting to users and in order to provide various additional services in broadcasting services in conformity with users' various demands for broadcasting services, methods for efficiently transmitting and receiving not only main data corresponding to a main broadcasting service in broadcasting services to be provided to users but also additional data corresponding to additional services in the broadcasting services have been proposed.

However, currently, in the digital broadcasting system, while users' demands for receiving not only the high definition broadcasting services but also the various additional services as just described above significantly increase, such users' demands are not sufficiently satisfied with. In other words, currently, in the digital broadcasting system, a method for providing the various additional services demanded by users, that is, a detailed method for transmitting and receiving additional data corresponding to the various additional services has not been proposed. In particular, recently, in the digital broadcasting system, although a method for transmitting and receiving additional data for providing additional services of broadcasting services has been proposed in too great a latitude, a problem is caused in that the method does not satisfy users' various demands for additional services at all.

Therefore, in order to stably provide not only high definition broadcasting services but also various additional services of the broadcasting services demanded by users in the communication system, for example, the digital broadcasting system, a method for transmitting not only main data of broadcasting data corresponding to a main broadcasting service of the broadcasting services and additional data corresponding to various additional services of the broadcasting services is needed in the art.

### SUMMARY OF THE INVENTION

An embodiment of the present invention is directed to an apparatus and a method for transmitting and receiving data in a communication system.

Another embodiment of the present invention is directed to an apparatus and a method for transmitting and receiving broadcasting data and additional data of the broadcasting data in a communication system.

Another embodiment of the present invention is directed to an apparatus and a method for transmitting and receiving data, which can provide not only high definition broadcasting services demanded by users in a communication system but also various additional services of the broadcasting services.

Another embodiment of the present invention is directed to an apparatus and a method for transmitting and receiving data, which can transmit and receive not only main data corresponding to a main broadcasting service of high definition broadcasting services demanded by users in a communication system but also a plurality of additional data corresponding to various additional services of the broadcasting services.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a data transmission apparatus of a communication system includes: a main data generator configured to generate main data corresponding to a main broadcasting service of broadcasting services; a main signal generator configured to generate a main signal of the main data; an additional data generator configured to generate a plurality of additional data corresponding to various additional services of the broadcasting services; an additional signal generator configured to generate a plurality of additional signals of the plurality of additional data; a power controller configured to control average power of the plurality of additional signals; a coupler configured to couple the main signal and the plurality of additional signals controlled in the average power thereof, and generate a broadcasting signal; and a transmitter configured to transmit the broadcasting signal.

In accordance with another embodiment of the present invention, a data reception apparatus of a communication system includes: a receiver configured to receive a broadcasting signal corresponding to broadcasting services, through a broadcasting channel; an additional signal recoverer configured to separate and recover a plurality of additional signals corresponding to various additional services of the broadcasting services, from the broadcasting signal; and an additional data recoverer configured to recover a plurality of additional data of the various additional services through the plurality of additional signals, and provide the various additional services.

In accordance with another embodiment of the present invention, a data transmitting method of a communication system includes: generating main data corresponding to a main broadcasting service of broadcasting services and a plurality of additional data corresponding to various additional services of the broadcasting services; generating a main signal of the main data and a plurality of additional signals of the plurality of additional data; controlling average power of the plurality of additional signals; and generating a broadcasting signal by coupling the main signal and the plurality of additional signals controlled in the average power thereof and transmitting the broadcasting signal.

In accordance with another embodiment of the present invention, a data receiving method of a communication system includes: receiving a broadcasting signal corresponding to broadcasting services, through a broadcasting channel; separating and recovering a plurality of additional signals corresponding to various additional services of the broadcasting services, from the broadcasting signal; and recovering a plurality of additional data of the various additional services through the plurality of additional signals, and providing the various additional services.

### BRIEF DESCRIPTION OF THE DRAWINGS

FIGS. 1 and 3 to 9 are diagrams schematically illustrating the structures of a data transmission apparatus in a communication system in accordance with exemplary embodiments of the present invention.

FIGS. 2 and 10 to 20 are diagrams schematically illustrating the structures of a data reception apparatus in a communication system in accordance with exemplary embodiments of the present invention.

FIGS. 21 to 25 are diagrams schematically illustrating the structures of a power controller of a data transmission apparatus in a communication system in accordance with exemplary embodiments of the present invention.

FIG. 26 is a flow chart schematically showing an operating procedure of a data transmission apparatus in a communication system in accordance with an exemplary embodiment of the present invention.

FIG. 27 is a flow chart schematically showing an operating procedure of a data reception apparatus in a communication system in accordance with an exemplary embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention propose an apparatus and a method for transmitting and receiving main data and a plurality of additional data of broadcasting data in a communication system, for example, a digital broadcasting system. In the exemplary embodiments of the present invention, the digital broadcasting system transmits and receives the broadcasting data by coupling the main data and the plurality of additional data so as to provide various types of high definition broadcasting services and various additional services of the broadcasting services to users.

Also, in the exemplary embodiments of the present invention, main broadcasting data corresponding to a main broadcasting service of high definition broadcasting services and a plurality of additional data corresponding to various additional services of the broadcasting services are transmitted and received by being coupled with each other as broadcasting data. In particular, as a plurality of various additional data corresponding to various additional services are simultaneously transmitted and received, the transmission efficiency of broadcasting data is improved, and not only high definition broadcasting services demanded by users but also various additional services of the broadcasting services are stably provided to the users.

A data transmission apparatus in accordance with the exemplary embodiments of the present invention generates main broadcasting data corresponding to the main broadcasting service and a plurality of additional data corresponding to the various additional services, generates and couples a main signal of the main broadcasting data and additional signals of the plurality of additional data, and transmits a broadcasting signal of the broadcasting data. A data reception apparatus in accordance with the exemplary embodiments of the present invention receives the broadcasting signal, separates and recovers a plurality of additional signals from the broadcasting signal, and recovers a plurality of additional data corresponding to the various additional services from the plurality of additional signals. Therefore, in the exemplary embodiments of the present invention, as described above, a plurality of various additional data corresponding to various additional services are simultaneously transmitted and received, and backward compatibility with a broadcasting signal is maintained so that the data transmission rate of a system may be increased.

Furthermore, in the exemplary embodiments of the present invention, in order to provide high definition broadcasting services and various additional services of the broadcasting services, broadcasting data, in which main data and a plurality of additional data are coupled with each other, is transmitted and received using a transmitter identification (TxID) signal. A broadcasting network may be controlled by analyzing the channels of the broadcasting data through the TxID signal. That is to say, a broadcasting network is controlled by analyzing the channels of broadcasting data through using a TxID signal, and accordingly, it is possible to efficiently provide broadcasting services demanded by users.

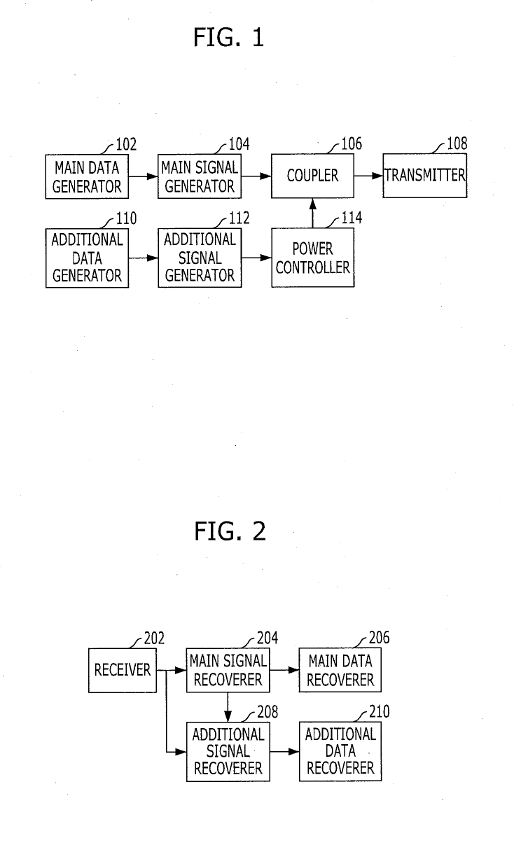

A data transmission apparatus in accordance with the exemplary embodiments of the present invention couples the TxID signal as well when coupling a main signal corresponding to the main data and a plurality of additional signals corresponding to the plurality of additional data, and transmits a broadcasting signal of broadcasting data. Also, a data reception apparatus in accordance with the exemplary embodiments of the present invention analyzes the channel of the broadcasting data using a TxID signal from the broadcasting signal transmitted from the data transmission apparatus, and provides high definition broadcasting services and various additional services of the broadcasting services. A data transmission apparatus of a communication system in accordance with an embodiment of the present invention will be described below in detail with reference to FIG. 1.

FIG. 1 is a diagram schematically illustrating the structure of a data transmission apparatus of a communication system in accordance with an exemplary embodiment of the present invention.

Referring to FIG. 1, the data transmission apparatus includes a main data generator 102 configured to generate main data corresponding to a main broadcasting service of broadcasting services so as to provide various types of high definition broadcasting services to users, a main signal generator 104 configured to receive the main data and generate a baseband main signal, an additional data generator 110 configured to generate a plurality of additional data corresponding to various additional services of the broadcasting services so as to provide various additional services to the broadcasting services in conformity with users' various demands for additional services, an additional signal generator 112 configured to receive the plurality of additional data and generate baseband additional signals, a power controller 114 configured to control the average power of the additional signals not to exert an influence on the main signal, a coupler 106 configured to couple the additional signals controlled in the average power thereof with the main signal, and a transmitter 108 configured to transmit a broadcasting signal in which the main signal and the additional signals are coupled with each other.

The main data generator 102 generates the main data of the main broadcasting service in the broadcasting services to be provided to the users, that is, main data of broadcasting data. The main signal generator 104 generates the main signal corresponding to the main data to transmit the main data. Also, the additional data generator 110 generates the additional data of the various additional services, that is, a plurality of additional data of the broadcasting data, to provide the various additional services in the broadcasting services. The additional signal generator 112 generates a plurality of additional signals corresponding to the plurality of additional data to transmit the plurality of additional data. The plurality of additional data and the plurality of additional signals may be generated by a single additional data generator and a single additional signal generator or by a plurality of additional data generators and a plurality of additional signal generators for the respective various additional services.

The power controller 114 controls the average power level of the plurality of additional signals. The power controller 114 controls the power of the plurality of additional signals depending upon the power level of the main signal, for example, to a power level lower than the power level of the main signal, so as to prevent the plurality of additional signals from exerting an influence on the main signal. The plurality of additional signals may be controlled in the average level thereof by a single power controller or a plurality of power controllers corresponding to the plurality of respective additional signals.

The coupler 106 couples the plurality of additional signals and the main signal with each other by inserting the plurality of additional signals controlled in the average power thereof by the power controller 114, into the main signal, and thereby, generates the broadcasting signal in which the plurality of additional signals and the main signal are coupled with each other. The transmitter 108 transmits the broadcasting signal in which the plurality of additional signals and the main signal are coupled with each other.

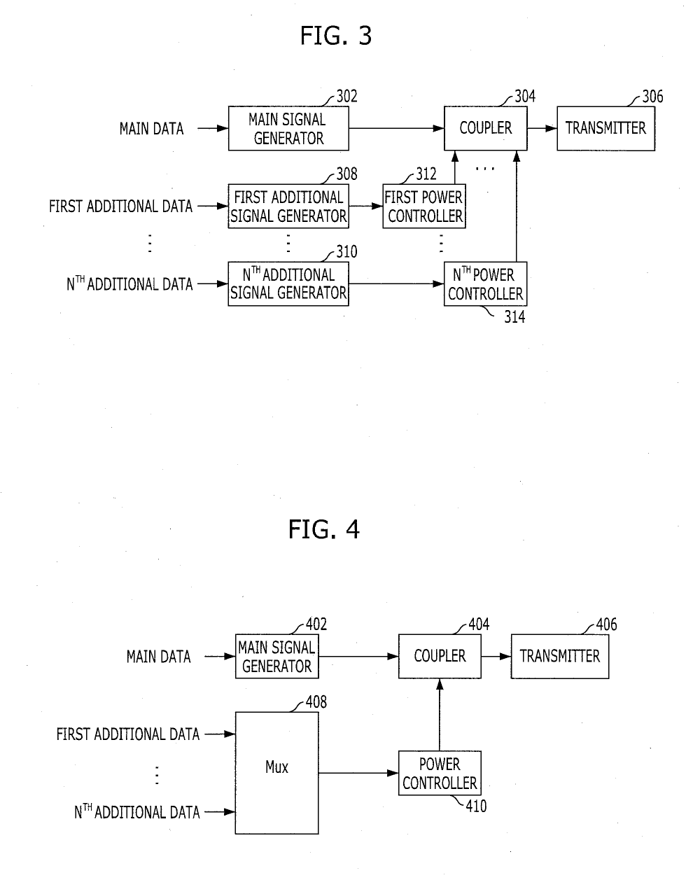

In the data transmission apparatus in accordance with the present embodiment of the invention, as the transmitter 108 transmits the broadcasting signal in which the plurality of additional signals and the main signal are coupled with each other, the plurality of additional data corresponding to the various additional services are simultaneously transmitted as the broadcasting data. Data transmission apparatuses in accordance with exemplary embodiments of the present invention will be described later in detail with reference to FIGS. 3 to 9. A data reception apparatus of a communication system in accordance with another embodiment of the present invention will be described below in detail with reference to FIG. 2.

FIG. 2 is a diagram schematically illustrating the structure of a data reception apparatus of a communication system in accordance with another exemplary embodiment of the present invention.

Referring to FIG. 2, the data reception apparatus includes a receiver 202 configured to receive a broadcasting signal of broadcasting data for providing various types of high definition broadcasting services to users, a main signal recoverer 204 configured to recover a main signal of main data corresponding to a main broadcasting service, from the received broadcasting signal, a main data recoverer 206 configured to recover the main data corresponding to the main broadcasting service, from the main signal, and provide the main broadcasting service to the users, an additional signal recoverer 208 configured to recover a plurality of additional signals of a plurality of additional data corresponding to various additional services, from the received broadcasting signal, and an additional data recoverer 210 configured to recover the plurality of additional data corresponding to the various additional services, from the plurality of additional signals, and provide the various additional services to the users.

The receiver 202 receives the broadcasting signal as the broadcasting data corresponding to broadcasting services to be provided to the users. As aforementioned above, the broadcasting signal is a signal in which the main signal of the main data corresponding to the main broadcasting service is coupled with the plurality of additional signals of the plurality of additional data corresponding to the additional services.

The main signal recoverer 204 separates the main signal from the broadcasting signal and recovers the main signal of the main data. The main data recoverer 206 recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The additional signal recoverer 208 separates the plurality of additional signals from the broadcasting signal and recovers the plurality of additional signals of the plurality of additional data. The additional data recoverer 210 recovers the plurality of additional data for providing the various additional services of the broadcasting services to the users, from the plurality of additional signals, and provides the additional services to the users. The plurality of additional signals and the plurality of additional data may be recovered by a single additional signal recoverer and a single additional data recoverer or by a plurality of additional signal recoverers and a plurality of additional data recoverers for the respective various additional services. The plurality of additional signals may be recovered from the main signal of the broadcasting signal or from different additional signals of the broadcasting signal.

In the data reception apparatus in accordance with the present embodiment of the invention, as the additional signal recoverer and the additional data recoverer recover the plurality of additional signals and the plurality of additional data from the broadcasting signal, the plurality of additional data corresponding to the various additional services may be simultaneously received and recovered as the broadcasting data. Data reception apparatuses in accordance with exemplary embodiments of the present invention will be described later in detail with reference to FIGS. 10 to 20. A data transmission apparatus of a communication system in accordance with another embodiment of the present invention will be described below in detail with reference to FIG. 3.

FIG. 3 is a diagram schematically illustrating the structure of a data transmission apparatus in accordance with another exemplary embodiment of the present invention. FIG. 3 is a diagram which is obtained by omitting the main data generator and the additional data generator in the data transmission apparatus shown in FIG. 1.

Referring to FIG. 3, the data transmission apparatus includes a main signal generator 302 configured to receive main data generated by a main data generator and corresponding to a main broadcasting service of broadcasting services so as to provide various types of high definition broadcasting services to users and generate a baseband main signal, a plurality of additional signal generators, for example, a first additional signal generator 308 to an N^{th} additional signal generator 310, configured to receive a plurality of additional data generated by a single additional data generator or a plurality of additional data generators and corresponding to various additional services of the broadcasting services so as to provide various additional services to the broadcasting services in conformity with users' various demands for additional services and generate respective baseband additional signals, a plurality of power controllers, for example, a first power controller 312 to an N^{th} power controller 314, configured to control the average power of the plurality of additional signals not to exert an influence on the main signal, a coupler 304 configured to couple the plurality of additional signals controlled in the average power thereof with the main signal, and a transmitter 306 configured to transmit a broadcasting signal in which the main signal and the plurality of additional signals are coupled with each other.

While not shown in detail in FIG. 3, as aforementioned above, the main data generator generates the main data of the main broadcasting service in the broadcasting services to be provided to the users, that is, main data of broadcasting data. The main signal generator 302 generates the main signal corresponding to the main data to transmit the main data.

Also, while not shown in detail in FIG. 3, the single additional data generator or the plurality of additional data generators generate additional data corresponding to the various additional services, for example, first additional data to N^{th} additional data of the broadcasting data, to provide the various additional services in the broadcasting services as aforementioned above. The first additional signal generator 308 to the N^{th} additional signal generator 310 generate a plurality of additional signals corresponding to the plurality of additional data to transmit the plurality of additional data. The first additional signal generator 308 generates a first additional signal of the first additional data, and the N^{th} additional signal generator 310 generates an N^{th} additional signal of the N^{th} additional data.

The first power controller 312 to the N^{th} power controller 314 control the average power levels of the plurality of additional signals, that is, the first additional signal to the N^{th} additional signal. The first power controller 312 to the N^{th} power controller 314 control the power of the first additional signal to the N^{th} additional signal depending upon the power level of the main signal, for example, to a power level lower than the power level of the main signal, so as to prevent the first additional signal to the N^{th} additional signal from exerting an influence on the main signal. The first power controller 312 controls the average power of the first additional signal, and the N^{th} power controller 314 controls the average power of the N^{th} additional signal.

The coupler 304 couples the first additional signal to the N^{th} additional signal and the main signal with each other by inserting the first additional signal to the N^{th} additional signal controlled in the average power thereof by the first power controller 312 to the N^{th} power controller 314, into the main signal, and thereby, generates the broadcasting signal in which the first additional signal to the N^{th} additional signal and the main signal are coupled with each other. The transmitter 306 transmits the broadcasting signal in which the first additional signal to the N^{th} additional signal and the main signal are coupled with each other.

In the data transmission apparatus in accordance with the another embodiment of the invention, as the transmitter 306 transmits the broadcasting signal in which the main signal of the main data and the plurality of additional signals are coupled with each other, the plurality of additional data corresponding to the various additional services are simultaneously transmitted as the broadcasting data. A data transmission apparatus in accordance with another embodiment of the present invention will be described below in detail with reference to FIG. 4.

FIG. 4 is a diagram schematically illustrating the structure of a data transmission apparatus in accordance with another exemplary embodiment of the present invention. FIG. 4 is a diagram which is obtained by omitting the main data generator and the additional data generator in the data transmission apparatus shown in FIG. 1.

Referring to FIG. 4, the data transmission apparatus includes a main signal generator 402 configured to receive main data generated by a main data generator and corresponding to a main broadcasting service of broadcasting services so as to provide various types of high definition broadcasting services to users and generate a baseband main signal, a multiplexer (hereinafter, referred to as a “MUX”) 408 configured to receive a plurality of additional data generated by a single additional data generator or a plurality of additional data generators and corresponding to various additional services of the broadcasting services so as to provide various additional services to the broadcasting services in conformity with users' various demands for additional services and generate a single baseband additional signal, a power controller 410 configured to control the average power of the single additional signal not to exert an influence on the main signal, a coupler 404 configured to couple the single additional signal controlled in the average power thereof with the main signal, and a transmitter 406 configured to transmit a broadcasting signal in which the main signal and the additional signal are coupled with each other.

While not shown in detail in FIG. 4, as aforementioned above, the main data generator generates the main data of the main broadcasting service in the broadcasting services to be provided to the users, that is, main data of broadcasting data. The main signal generator 402 generates the main signal corresponding to the main data to transmit the main data.

Also, while not shown in detail in FIG. 4, the single additional data generator or the plurality of additional data generators generate additional data corresponding to the various additional services, for example, first additional data to N^{th} additional data of the broadcasting data, to provide the various additional services in the broadcasting services as aforementioned above. The MUX 408 multiplexes the plurality of additional data and generates the single additional data corresponding to the plurality of additional data to transmit the plurality of additional data. The single additional data is a signal in which the plurality of additional data are multiplexed.

The power controller 410 controls the average power level of the single additional signal in which the plurality of additional data are multiplexed. The power controller 410 controls the power of the additional signal depending upon the power level of the main signal, for example, to a power level lower than the power level of the main signal, so as to prevent the additional signal from exerting an influence on the main signal.

The coupler 404 couples the additional signal and the main signal with each other by inserting the additional signal controlled in the average power thereof by the power controller 410, that is, the additional signal controlled in the average power thereof by multiplexing the plurality of additional data, into the main signal, and thereby, generates the broadcasting signal in which the additional signal and the main signal are coupled with each other. The transmitter 406 transmits the broadcasting signal in which the additional signal and the main signal are coupled with each other.

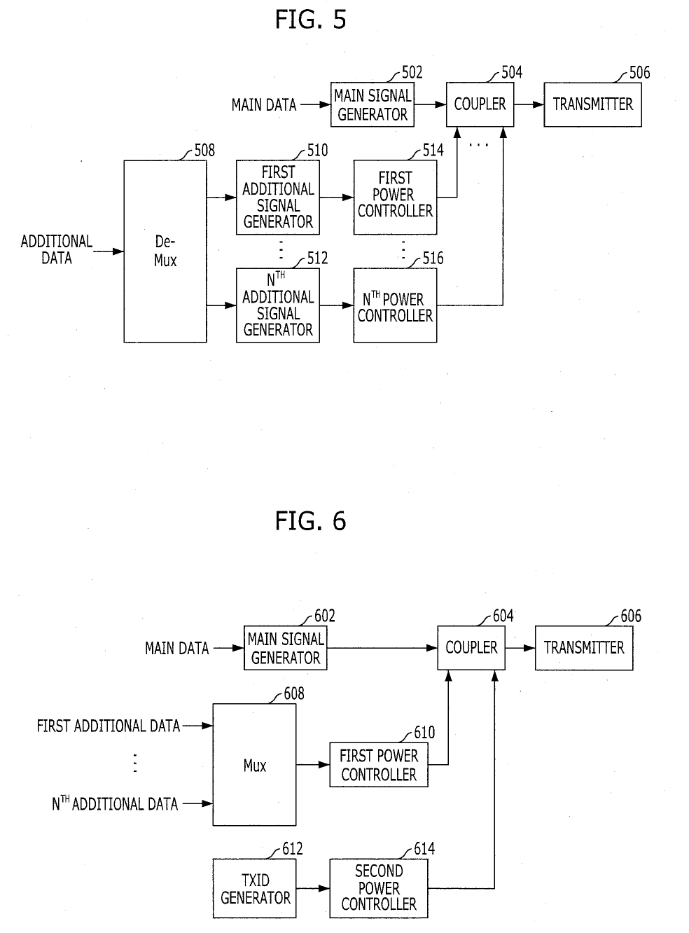

In the data transmission apparatus in accordance with the another embodiment of the invention, as the MUX 408 multiplexes the plurality of additional data into the single additional signal and the transmitter 406 transmits the broadcasting signal in which the main signal of the main data and the additional signal of the plurality of additional data are coupled with each other, the plurality of additional data corresponding to the various additional services are simultaneously transmitted as the broadcasting data. A data transmission apparatus in accordance with another embodiment of the present invention will be described below in detail with reference to FIG. 5.

FIG. 5 is a diagram schematically illustrating the structure of a data transmission apparatus in accordance with another exemplary embodiment of the present invention. FIG. 5 is a diagram which is obtained by omitting the main data generator and the additional data generator in the data transmission apparatus shown in FIG. 1.

Referring to FIG. 5, the data transmission apparatus includes a main signal generator 502 configured to receive main data generated by a main data generator and corresponding to a main broadcasting service of broadcasting services so as to provide various types of high definition broadcasting services to users and generate a baseband main signal, a demultiplexer (hereinafter, referred to as a “De-MUX”) 508 configured to receive a single additional data generated by a single additional data generator and corresponding to various additional services of the broadcasting services so as to provide various additional services to the broadcasting services in conformity with users' various demands for additional services and generate a plurality of additional data, a plurality of additional signal generators, for example, a first additional signal generator 510 to an N^{th} additional signal generator 512, configured to receive the plurality of additional data generated by the De-MUX 508 and corresponding to the various additional services of the broadcasting services and generate respective baseband additional signals, a plurality of power controllers, for example, a first power controller 514 to an N^{th} power controller 516, configured to control the average power of the plurality of additional signals not to exert an influence on the main signal, a coupler 504 configured to couple the plurality of additional signals controlled in the average power thereof with the main signal, and a transmitter 506 configured to transmit a broadcasting signal in which the main signal and the plurality of additional signals are coupled with each other.

While not shown in detail in FIG. 5, as aforementioned above, the main data generator generates the main data of the main broadcasting service in the broadcasting services to be provided to the users, that is, main data of broadcasting data. The main signal generator 502 generates the main signal corresponding to the main data to transmit the main data.

Also, while not shown in detail in FIG. 5, the single additional data generator generates the single additional data corresponding to the various additional services to provide the various additional services in the broadcasting services as aforementioned above. The De-MUX 508 receives the single additional data, demultiplexes the single additional data, and generates the plurality of additional data corresponding to the various additional services, for example, first additional data to N^{th} additional data of the broadcasting data. The first additional signal generator 510 to the N^{th} additional signal generator 512 generate a plurality of additional signals corresponding to the plurality of additional data to transmit the plurality of additional data. The first additional signal generator 510 generates a first additional signal of the first additional data, and the N^{th} additional signal generator 512 generates an N^{th} additional signal of the N^{th} additional data.

The first power controller 514 to the N^{th} power controller 516 control the average power levels of the plurality of additional signals, that is, the first additional signal to the N^{th} additional signal. The first power controller 514 to the N^{th} power controller 516 control the power of the first additional signal to the N^{th} additional signal depending upon the power level of the main signal, for example, to a power level lower than the power level of the main signal, so as to prevent the first additional signal to the N^{th} additional signal from exerting an influence on the main signal. The first power controller 514 controls the average power of the first additional signal, and the N^{th} power controller 516 controls the average power of the N^{th} additional signal.

The coupler 504 couples the first additional signal to the N^{th} additional signal and the main signal with each other by inserting the first additional signal to the N^{th} additional signal controlled in the average power thereof by the first power controller 514 to the N^{th} power controller 516, into the main signal, and thereby, generates the broadcasting signal in which the first additional signal to the N^{th} additional signal and the main signal are coupled with each other. The transmitter 506 transmits the broadcasting signal in which the first additional signal to the N^{th} additional signal and the main signal are coupled with each other.

In the data transmission apparatus in accordance with the another embodiment of the invention, as the De-MUX 508 demultiplexes the single additional data into the plurality of additional data corresponding to the various additional services and the transmitter 506 transmits the broadcasting signal in which the main signal of the main data and the plurality of additional signals of the plurality of additional data are coupled with each other, the plurality of additional data corresponding to the various additional services are simultaneously transmitted as the broadcasting data. A data transmission apparatus in accordance with another embodiment of the present invention will be described below in detail with reference to FIG. 6.

FIG. 6 is a diagram schematically illustrating the structure of a data transmission apparatus in accordance with another exemplary embodiment of the present invention. FIG. 6 is a diagram which is obtained by omitting the main data generator and the additional data generator in the data transmission apparatus shown in FIG. 1.

Referring to FIG. 6, the data transmission apparatus includes a main signal generator 602 configured to receive main data generated by a main data generator and corresponding to a main broadcasting service of broadcasting services so as to provide various types of high definition broadcasting services to users and generate a baseband main signal, a MUX 608 configured to receive a plurality of additional data generated by a single additional data generator or a plurality of additional data generators and corresponding to various additional services of the broadcasting services so as to provide various additional services to the broadcasting services in conformity with users' various demands for additional services and generate a single baseband additional signal, a first power controller 610 configured to control the average power of the single additional signal not to exert an influence on the main signal, a TxID generator 612 configured to generate a TxID signal for analyzing channels when providing the various types of broadcasting services, a second power controller 614 configured to control the average power of the TxID signal not to exert an influence on the main signal, a coupler 604 configured to couple the single additional signal and the TxID signal controlled in the average power thereof with the main signal, and a transmitter 606 configured to transmit a broadcasting signal in which the main signal and the additional signal and the TxID signal are coupled with each other.

While not shown in detail in FIG. 6, as aforementioned above, the main data generator generates the main data of the main broadcasting service in the broadcasting services to be provided to the users, that is, main data of broadcasting data. The main signal generator 402 generates the main signal corresponding to the main data to transmit the main data.

Also, while not shown in detail in FIG. 6, the single additional data generator or the plurality of additional data generators generate additional data corresponding to the various additional services, for example, first additional data to N^{th} additional data of the broadcasting data, to provide the various additional services in the broadcasting services as aforementioned above. The MUX 608 multiplexes the plurality of additional data and generates the single additional data corresponding to the plurality of additional data to transmit the plurality of additional data. The single additional data is a signal in which the plurality of additional data are multiplexed.

The first power controller 610 controls the average power level of the single additional signal in which the plurality of additional data are multiplexed. The first power controller 610 controls the power of the additional signal depending upon the power level of the main signal, for example, to a power level lower than the power level of the main signal, so as to prevent the additional signal from exerting an influence on the main signal.

The TxID generator 612 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The second power controller 614 controls the average power level of the TxID signal. The second power controller 614 controls the power of the TxID signal depending upon the power level of the main signal, for example, to a power level lower than the power level of the main signal, so as to prevent the TxID signal from exerting an influence on the main signal.

The coupler 604 couples the additional signal and the TxID signal with the main signal by inserting the additional signal controlled in the average power thereof by the first power controller 610, that is, the additional signal controlled in the average power thereof by multiplexing the plurality of additional data, and the TxID signal controlled in the average power thereof by the second power controller 614, into the main signal, and thereby, generates the broadcasting signal in which the additional signal and the TxID signal and the main signal are coupled with each other. The transmitter 606 transmits the broadcasting signal in which the additional signal and the TxID signal are coupled with the main signal.

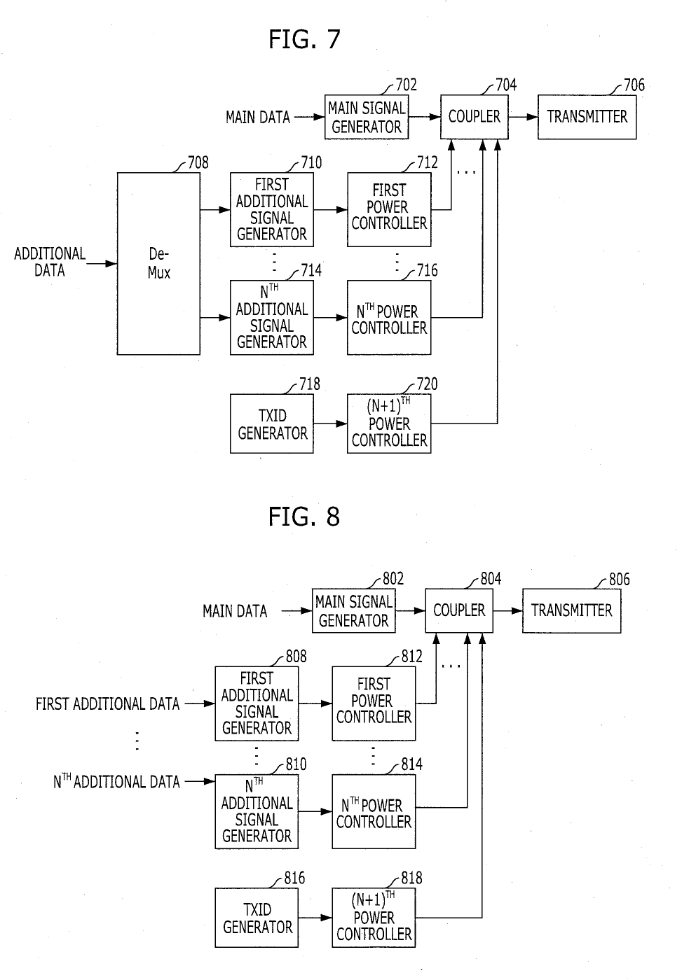

In the data transmission apparatus in accordance with the another embodiment of the invention, as the MUX 608 multiplexes the plurality of additional data into the single additional signal and the transmitter 606 transmits the broadcasting signal in which the main signal of the main data is coupled with the additional signal of the plurality of additional data and the TxID signal for analyzing broadcasting channels, the plurality of additional data corresponding to the various additional services are simultaneously transmitted as the broadcasting data. A data transmission apparatus in accordance with another embodiment of the present invention will be described below in detail with reference to FIG. 7.

FIG. 7 is a diagram schematically illustrating the structure of a data transmission apparatus in accordance with another exemplary embodiment of the present invention. FIG. 7 is a diagram which is obtained by omitting the main data generator and the additional data generator in the data transmission apparatus shown in FIG. 1.

Referring to FIG. 7, the data transmission apparatus includes a main signal generator 702 configured to receive main data generated by a main data generator and corresponding to a main broadcasting service of broadcasting services so as to provide various types of high definition broadcasting services to users and generate a baseband main signal, a De-MUX 708 configured to receive a single additional data generated by a single additional data generator and corresponding to various additional services of the broadcasting services so as to provide various additional services to the broadcasting services in conformity with users' various demands for additional services and generate a plurality of additional data, a plurality of additional signal generators, for example, a first additional signal generator 710 to an N^{th} additional signal generator 714, configured to receive the plurality of additional data generated by the De-MUX 708 and corresponding to the various additional services of the broadcasting services and generate respective baseband additional signals, a plurality of power controllers, for example, a first power controller 712 to an N^{th} power controller 716, configured to control the average power of the plurality of additional signals not to exert an influence on the main signal, a TxID generator 718 configured to generate a TxID signal for analyzing channels when providing the various types of broadcasting services, an (N+1)^{th} power controller 720 configured to control the average power of the TxID signal not to exert an influence on the main signal, a coupler 704 configured to couple the plurality of additional signals and the TxID signal controlled in the average power thereof with the main signal, and a transmitter 706 configured to transmit a broadcasting signal in which the main signal and the plurality of additional signals and the TxID signal are coupled with each other.

While not shown in detail in FIG. 7, as aforementioned above, the main data generator generates the main data of the main broadcasting service in the broadcasting services to be provided to the users, that is, main data of broadcasting data. The main signal generator 702 generates the main signal corresponding to the main data to transmit the main data.

Also, while not shown in detail in FIG. 7, the single additional data generator generates the single additional data corresponding to the various additional services to provide the various additional services in the broadcasting services as aforementioned above. The De-MUX 708 receives the single additional data, demultiplexes the single additional data, and generates the plurality of additional data corresponding to the various additional services, for example, first additional data to N^{th} additional data of the broadcasting data. The first additional signal generator 710 to the N^{th} additional signal generator 714 generate a plurality of additional signals corresponding to the plurality of additional data to transmit the plurality of additional data. The first additional signal generator 710 generates a first additional signal of the first additional data, and the N^{th} additional signal generator 714 generates an N^{th} additional signal of the N^{th} additional data.

The first power controller 712 to the N^{th} power controller 716 control the average power levels of the plurality of additional signals, that is, the first additional signal to the N^{th} additional signal. The first power controller 712 to the N^{th} power controller 716 control the power of the first additional signal to the N^{th} additional signal depending upon the power level of the main signal, for example, to a power level lower than the power level of the main signal, so as to prevent the first additional signal to the N^{th} additional signal from exerting an influence on the main signal. The first power controller 712 controls the average power of the first additional signal, and the N^{th} power controller 716 controls the average power of the N^{th} additional signal.

The TxID generator 718 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The (N+1)^{th} power controller 720 controls the average power level of the TxID signal. The (N+1)^{th} power controller 720 controls the power of the TxID signal depending upon the power level of the main signal, for example, to a power level lower than the power level of the main signal, so as to prevent the TxID signal from exerting an influence on the main signal.

The coupler 704 couples the first additional signal to the N^{th} additional signal and the TxID signal with the main signal by inserting the first additional signal to the N^{th} additional signal controlled in the average power thereof by the first power controller 712 to the N^{th} power controller 716 and the TxID signal controlled in the average power thereof by the (N+1)^{th} power controller 720, into the main signal, and thereby, generates the broadcasting signal in which the first additional signal to the N^{th} additional signal and the TxID signal and the main signal are coupled with each other. The transmitter 706 transmits the broadcasting signal in which the first additional signal to the N^{th} additional signal and the TxID signal and the main signal are coupled with each other.

In the data transmission apparatus in accordance with the another embodiment of the invention, as the De-MUX 708 demultiplexes the single additional data into the plurality of additional data corresponding to the various additional services and the transmitter 706 transmits the broadcasting signal in which the main signal of the main data and the plurality of additional signals of the plurality of additional data and the TxID signal for analyzing broadcasting channels are coupled with each other, the plurality of additional data corresponding to the various additional services are simultaneously transmitted as the broadcasting data. A data transmission apparatus in accordance with another embodiment of the present invention will be described below in detail with reference to FIG. 8.

FIG. 8 is a diagram schematically illustrating the structure of a data transmission apparatus in accordance with another exemplary embodiment of the present invention. FIG. 8 is a diagram which is obtained by omitting the main data generator and the additional data generator in the data transmission apparatus shown in FIG. 1.

Referring to FIG. 8, the data transmission apparatus includes a main signal generator 802 configured to receive main data generated by a main data generator and corresponding to a main broadcasting service of broadcasting services so as to provide various types of high definition broadcasting services to users and generate a baseband main signal, a plurality of additional signal generators, for example, a first additional signal generator 808 to an N^{th} additional signal generator 810, configured to receive a plurality of additional data generated by a single additional data generator or a plurality of additional data generators and corresponding to various additional services of the broadcasting services so as to provide various additional services to the broadcasting services in conformity with users' various demands for additional services and generate respective baseband additional signals, a plurality of power controllers, for example, a first power controller 812 to an N^{th} power controller 814, configured to control the average power of the plurality of additional signals not to exert an influence on the main signal, a TxID generator 816 configured to generate a TxID signal for analyzing channels when providing the various types of broadcasting services, an (N+1)^{th} power controller 818 configured to control the average power of the TxID signal not to exert an influence on the main signal, a coupler 804 configured to couple the plurality of additional signals and the TxID signal controlled in the average power thereof with the main signal, and a transmitter 806 configured to transmit a broadcasting signal in which the main signal and the plurality of additional signals and the TxID signal are coupled with each other.

While not shown in detail in FIG. 8, as aforementioned above, the main data generator generates the main data of the main broadcasting service in the broadcasting services to be provided to the users, that is, main data of broadcasting data. The main signal generator 702 generates the main signal corresponding to the main data to transmit the main data.

Also, while not shown in detail in FIG. 8, the single additional data generator or the plurality of additional data generators generate additional data corresponding to the various additional services, for example, first additional data to N^{th} additional data of the broadcasting data, to provide the various additional services in the broadcasting services as aforementioned above. The first additional signal generator 808 to the N^{th} additional signal generator 810 generate a plurality of additional signals corresponding to the plurality of additional data to transmit the plurality of additional data. The first additional signal generator 808 generates a first additional signal of the first additional data, and the N^{th} additional signal generator 810 generates an N^{th} additional signal of the N^{th} additional data.

The first power controller 812 to the N^{th} power controller 814 control the average power levels of the plurality of additional signals, that is, the first additional signal to the N^{th} additional signal. The first power controller 812 to the N^{th} power controller 814 control the power of the first additional signal to the N^{th} additional signal depending upon the power level of the main signal, for example, to a power level lower than the power level of the main signal, so as to prevent the first additional signal to the N^{th} additional signal from exerting an influence on the main signal. The first power controller 812 controls the average power of the first additional signal, and the N^{th} power controller 814 controls the average power of the N^{th} additional signal.

The TxID generator 816 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The (N+1)^{th} power controller 818 controls the average power level of the TxID signal. The (N+1)^{th} power controller 818 controls the power of the TxID signal depending upon the power level of the main signal, for example, to a power level lower than the power level of the main signal, so as to prevent the TxID signal from exerting an influence on the main signal.

The coupler 804 couples the first additional signal to the N^{th} additional signal and the TxID signal with the main signal by inserting the first additional signal to the N^{th} additional signal controlled in the average power thereof by the first power controller 812 to the N^{th} power controller 814 and the TxID signal controlled in the average power thereof by the (N+1)^{th} power controller 818, into the main signal, and thereby, generates the broadcasting signal in which the first additional signal to the N^{th} additional signal and the TxID signal and the main signal are coupled with each other. The transmitter 806 transmits the broadcasting signal in which the first additional signal to the N^{th} additional signal and the TxID signal and the main signal are coupled with each other.

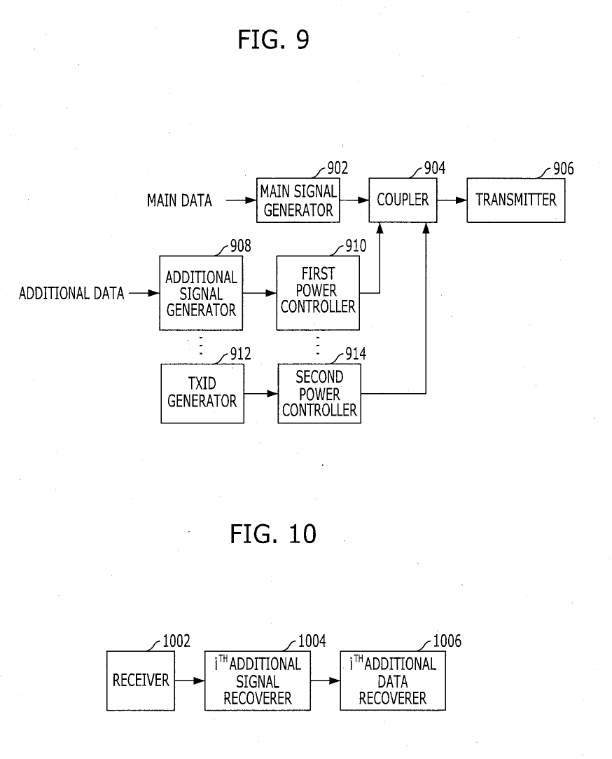

In the data transmission apparatus in accordance with the another embodiment of the invention, as the transmitter 806 transmits the broadcasting signal in which the main signal of the main data and the plurality of additional signals and the TxID signal for analyzing broadcasting channels are coupled with each other, the plurality of additional data corresponding to the various additional services are simultaneously transmitted as the broadcasting data. A data transmission apparatus in accordance with another embodiment of the present invention will be described below in detail with reference to FIG. 9.

FIG. 9 is a diagram schematically illustrating the structure of a data transmission apparatus in accordance with another exemplary embodiment of the present invention. FIG. 9 is a diagram which is obtained by omitting the main data generator and the additional data generator in the data transmission apparatus shown in FIG. 1.

Referring to FIG. 9, the data transmission apparatus includes a main signal generator 902 configured to receive main data generated by a main data generator and corresponding to a main broadcasting service of broadcasting services so as to provide various types of high definition broadcasting services to users and generate a baseband main signal, an additional signal generator 908 configured to receive single data generated by a single additional data generator and corresponding to various additional services of the broadcasting services so as to provide various additional services to the broadcasting services in conformity with users' various demands for additional services and generate a baseband additional signal, a first power controller 910 configured to control the average power of the additional signal not to exert an influence on the main signal, a TxID generator 912 configured to generate a TxID signal for analyzing channels when providing the various types of broadcasting services, a second power controller 914 configured to control the average power of the TxID signal not to exert an influence on the main signal, a coupler 904 configured to couple the single additional signal and the TxID signal controlled in the average power thereof with the main signal, and a transmitter 906 configured to transmit a broadcasting signal in which the main signal and the additional signal and the TxID signal are coupled with each other.

While not shown in detail in FIG. 9, as aforementioned above, the main data generator generates the main data of the main broadcasting service in the broadcasting services to be provided to the users, that is, main data of broadcasting data. The main signal generator 402 generates the main signal corresponding to the main data to transmit the main data.

Also, while not shown in detail in FIG. 9, the single additional data generator generates single additional data corresponding to the various additional services to provide the various additional services in the broadcasting services as aforementioned above. The additional signal generator 908 generates the additional signal of the additional data corresponding to the various additional services to transmit the additional data.

The first power controller 910 controls the average power level of the additional signal. The first power controller 910 controls the power of the additional signal depending upon the power level of the main signal, for example, to a power level lower than the power level of the main signal, so as to prevent the additional signal from exerting an influence on the main signal.

The TxID generator 912 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The second power controller 914 controls the average power level of the TxID signal. The second power controller 914 controls the power of the TxID signal depending upon the power level of the main signal, for example, to a power level lower than the power level of the main signal, so as to prevent the TxID signal from exerting an influence on the main signal.

The coupler 904 couples the additional signal and the TxID signal with the main signal by inserting the additional signal controlled in the average power thereof by the first power controller 910 and the TxID signal controlled in the average power thereof by the second power controller 914, into the main signal, and thereby, generates the broadcasting signal in which the additional signal and the TxID signal and the main signal are coupled with each other. The transmitter 906 transmits the broadcasting signal in which the additional signal and the TxID signal are coupled with the main signal.

In the data transmission apparatus in accordance with the another embodiment of the invention, as the transmitter 906 transmits the broadcasting signal in which the main signal of the main data is coupled with the additional signal of the additional data corresponding to the various additional services and the TxID signal for analyzing broadcasting channels, additional data corresponding to various additional services are simultaneously transmitted as the broadcasting data. A data reception apparatus of a communication system in accordance with another embodiment of the present invention will be described below in detail with reference to FIG. 10.

FIG. 10 is a diagram schematically illustrating the structure of a data reception apparatus in accordance with another exemplary embodiment of the present invention. FIG. 10 is a diagram which schematically illustrates only the components disposed on a path for receiving additional data in the data reception apparatus shown in FIG. 2.

Referring to FIG. 10, the data reception apparatus includes a receiver 1002 configured to receive a broadcasting signal of broadcasting data for providing various types of high definition broadcasting services to users, an i^{th} additional signal recoverer 1004 configured to recover a random i^{th} additional signal among a plurality of additional signals of a plurality of data corresponding to various additional services from the received broadcasting signal, and an i^{th} additional data recoverer 1006 configured to recover i^{th} additional data corresponding to an i^{th} additional service among the various additional services through i^{th} the additional signal and provide the i^{th} additional service to the users.

The receiver 1002 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 10, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The i^{th} additional signal recoverer 1004 separates the i^{th} additional signal corresponding to the random i^{th} additional service among the various additional services, from the broadcasting signal, and recovers the i^{th} additional signal of the i^{th} additional data. The i^{th} additional data recoverer 1006 recovers the i^{th} additional data for providing the i^{th} additional service among the various additional services of the broadcasting services to the users, from the i^{th} additional signal, and provides the i^{th} additional service to the users.

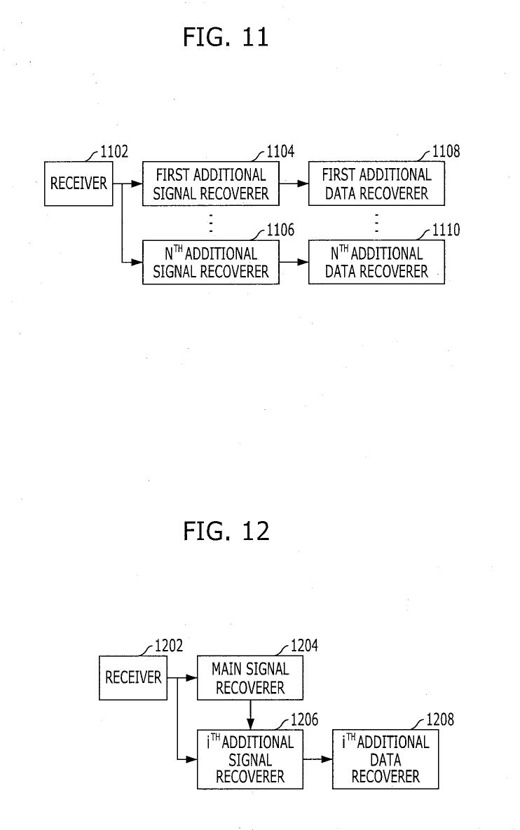

In the data reception apparatus in accordance with the another embodiment of the invention, as the i^{th} additional signal recoverer 1004 and the i^{th} additional data recoverer 1006 recover the random i^{th} additional signal and the random the i^{th} additional data from the broadcasting signal in which the main signal of the main data and the plurality of additional signals of the plurality of additional data are coupled with each other, the plurality of additional data corresponding to the various additional services may be simultaneously received as the broadcasting data. In particular, the i^{th} additional signal and the i^{th} additional data corresponding to the additional service demanded by the users among the various additional services, for example, the random i^{th} additional service, are recovered, and the corresponding additional service demanded by the users is provided to the users. A data reception apparatus in accordance with another embodiment of the present invention will be described below in detail with reference to FIG. 11.

FIG. 11 is a diagram schematically illustrating the structure of a data reception apparatus in accordance with another exemplary embodiment of the present invention. FIG. 11 is a diagram which schematically illustrates only the components disposed on a path for receiving additional data in the data reception apparatus shown in FIG. 2.

Referring to FIG. 11, the data reception apparatus includes a receiver 1102 configured to receive a broadcasting signal of broadcasting data for providing various types of high definition broadcasting services to users, a plurality of additional signal recoverers, for example, a first additional signal recoverer 1104 to an N^{th} additional signal recoverer 1106, configured to respectively recover a plurality of additional signals of a plurality of data corresponding to various additional services, from the received broadcasting signal, and a plurality of additional data recoverers, for example, a first additional data recoverer 1108 to an N^{th} additional data recoverer 1110, configured to respectively recover the plurality of additional data corresponding to the various additional services, through the plurality of additional services, and respectively provide the various additional services to the users.

The receiver 1102 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 11, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The first additional signal recoverer 1104 to the N^{th} additional signal recoverer 1106 separate the plurality of respective additional signals from the received broadcasting signal and recover the plurality of additional signals. Here, the first additional signal recoverer 1104 separates and recovers a first additional signal among the plurality of additional signals, from the broadcasting signal, and the N^{th} additional signal recoverer 1106 separates and recovers an N^{th} additional signal among the plurality of additional signals, from the broadcasting signal.

The first additional data recoverer 1108 to the N^{th} additional data recoverer 1110 recover the plurality of additional data for providing the various additional services of the broadcasting services to the users, from the plurality of additional signals, and provide the various additional services to the users. Here, the first additional data recoverer 1108 recovers first additional data from the first additional signal and provides a first additional service among the various additional services, and the N^{th} additional data recoverer 1110 recovers N^{th} additional data from the N^{th} additional signal and provides an N^{th} additional service among the various additional services.

In the data reception apparatus in accordance with the another embodiment of the invention, as the plurality of additional signal recoverers and the plurality of additional data recoverers recover the plurality of additional signals and the plurality of data, from the broadcasting signal in which the main signal of the main data and the plurality of additional signals of the plurality of additional data are coupled with each other, the plurality of additional data corresponding to the various additional services may be simultaneously received as the broadcasting data, and the various additional services may be provided to the users. A data reception apparatus in accordance with another embodiment of the present invention will be described below in detail with reference to FIG. 12.

FIG. 12 is a diagram schematically illustrating the structure of a data reception apparatus in accordance with another exemplary embodiment of the present invention.

Referring to FIG. 12, the data reception apparatus includes a receiver 1202 configured to receive a broadcasting signal of broadcasting data for providing various types of high definition broadcasting services to users, a main signal recoverer 1204 configured to recover a main signal of main data corresponding to a main broadcasting service, from the received broadcasting signal, an i^{th} additional signal recoverer 1206 configured to recover a random i^{th} additional signal among a plurality of additional signals of a plurality of data corresponding to various additional services from the received broadcasting signal, by using the main signal, and an i^{th} additional data recoverer 1208 configured to recover i^{th} additional data corresponding to an i^{th} additional service among the various additional services through the i^{th} additional signal and provide the i^{th} additional service to the users.

The receiver 1202 receives the broadcasting signal as the broadcasting data corresponding to the broadcasting services to be provided to the users. As aforementioned above, the broadcasting signal is a signal in which the main signal of the main data corresponding to the main broadcasting service and the plurality of additional signals of the plurality of additional data corresponding to the various additional services are coupled with each other.

The data reception apparatus includes the main signal recoverer 1204 configured to recover the main signal of the main data corresponding to the main broadcasting service, from the received broadcasting signal, and a main data recoverer (not shown in FIG. 12) configured to recover the main data corresponding to the main broadcasting service, from the main signal. The main signal recoverer 1204 separates the main signal from the broadcasting signal and recovers the main signal of the main data. The main data recoverer recovers the main data for providing the main broadcasting service of the broadcasting services to the users, from the main signal, and provides the main broadcasting service to the users.

The i^{th} additional signal recoverer 1206 separates the i^{th} additional signal corresponding to the random i^{th} additional service among the various additional services, from the broadcasting signal by using the main signal, and recovers the i^{th} additional signal of the i^{th} additional data. The i^{th} additional data recoverer 1208 recovers the i^{th} additional data for providing the i^{th} additional service among the various additional services of the broadcasting services to the users, from the i^{th} additional signal, and provides the i^{th} additional service to the users.

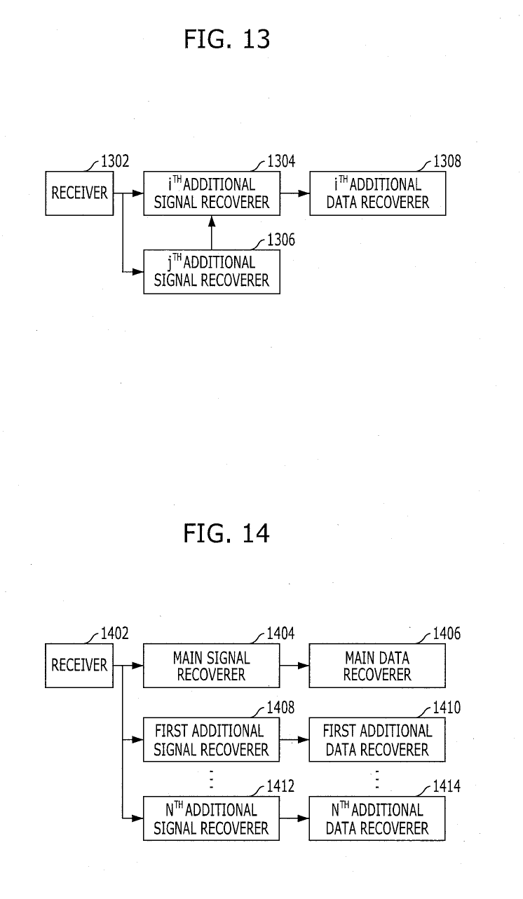

In the data reception apparatus in accordance with the another embodiment of the invention, as the i^{th} additional signal recoverer 1206 and the i^{th} additional data recoverer 1208 recover the random i^{th} additional signal and the random the i^{th} additional data from the broadcasting signal in which the main signal of the main data and the plurality of additional signals of the plurality of additional data are coupled with each other, by using the main signal, the plurality of additional data corresponding to the various additional services may be simultaneously received as the broadcasting data. In particular, the i^{th} additional signal and the i^{th} additional data corresponding to the additional service demanded by the users among the various additional services, for example, the random i^{th} additional service, are recovered, and the corresponding additional service demanded by the users is provided to the users. A data reception apparatus in accordance with another embodiment of the present invention will be described below in detail with reference to FIG. 13.

FIG. 13 is a diagram schematically illustrating the structure of a data reception apparatus in accordance with another exemplary embodiment of the present invention. FIG. 13 is a diagram which schematically illustrates only the components disposed on a path for receiving additional data in the data reception apparatus shown in FIG. 2.

Referring to FIG. 13, the data reception apparatus includes a receiver 1302 configured to receive a broadcasting signal of broadcasting data for providing various types of high definition broadcasting services to users, an j^{th} additional signal recoverer 1306 configured to recover a random j^{th} additional signal among a plurality of additional signals of a plurality of data corresponding to various additional services from the received broadcasting signal, an i^{th} additional signal recoverer 1304 configured to recover a random i^{th} additional signal among the plurality of additional signals of the plurality of data corresponding to the various additional services from the received broadcasting signal, by using the random j^{th} additional signal, and an i^{th} additional data recoverer 1308 configured to recover i^{th} additional data corresponding to an i^{th} additional service among the various additional services through the i^{th} additional signal and provide the i^{th} additional service to the users.

The receiver 1302 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 13, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The j^{th} additional signal recoverer 1306 separates the j^{th} additional signal corresponding to the random j^{th} additional service among the various additional services, from the broadcasting signal, and recovers the j^{th} additional signal of the j^{th} additional data. In other words, the j^{th} additional data recoverer 1306 separates and recovers the random j^{th} additional data among the plurality of additional signals included in the broadcasting signal.

The i^{th} additional signal recoverer 1304 separates the i^{th} additional signal corresponding to the random i^{th} additional service among the various additional services, from the broadcasting signal, by using the random j^{th} additional signal, and recovers the i^{th} additional signal of the i^{th} additional data. The i^{th} additional data recoverer 1308 recovers the i^{th} additional data for providing the i^{th} additional service among the various additional services of the broadcasting services to the users, from the i^{th} additional signal, and provides the i^{th} additional service to the users.

In the data reception apparatus in accordance with the another embodiment of the invention, as the j^{th} additional signal recoverer 1306 recovers the random j^{th} additional signal from the broadcasting signal in which the main signal of the main data and the plurality of additional signals of the plurality of additional data are coupled with each other and the i^{th} additional signal recoverer 1304 and the i^{th} additional data recoverer 1308 recover the random i^{th} additional signal and the random the i^{th} additional data from the broadcasting signal in which the main signal of the main data and the plurality of additional signals of the plurality of additional data are coupled with each other, by using the random j^{th} additional signal, the plurality of additional data corresponding to the various additional services may be simultaneously received as the broadcasting data. In particular, the i^{th} additional signal and the i^{th} additional data corresponding to the additional service demanded by the users among the various additional services, for example, the random i^{th} additional service, are recovered, and the corresponding additional service demanded by the users is provided to the users. A data reception apparatus in accordance with another embodiment of the present invention will be described below in detail with reference to FIG. 14.

FIG. 14 is a diagram schematically illustrating the structure of a data reception apparatus in accordance with another exemplary embodiment of the present invention.

Referring to FIG. 14, the data reception apparatus includes a receiver 1402 configured to receive a broadcasting signal of broadcasting data for providing various types of high definition broadcasting services to users, a main signal recoverer 1404 configured to recover a main signal of main data corresponding to a main broadcasting service, from the received broadcasting signal, a main data recoverer 1406 configured to recover the main data corresponding to the main broadcasting service, from the main signal, and provide the main broadcasting service to the users, a plurality of additional signal recoverers, for example, a first additional signal recoverer 1408 to an N^{th} additional signal recoverer 1412, configured to respectively recover a plurality of additional signals of a plurality of data corresponding to various additional services, from the received broadcasting signal, and a plurality of additional data recoverers, for example, a first additional data recoverer 1410 to an N^{th} additional data recoverer 1414, configured to respectively recover the plurality of additional data corresponding to the various additional services, through the plurality of additional services, and respectively provide the various additional services to the users.

The receiver 1402 receives the broadcasting signal as the broadcasting data corresponding to the broadcasting services to be provided to the users. As aforementioned above, the broadcasting signal is a signal in which the main signal of the main data corresponding to the main broadcasting service and the plurality of additional signals of the plurality of additional data corresponding to the various additional services are coupled with each other.

The main signal recoverer 1404 separates the main signal from the broadcasting signal and recovers the main signal of the main data. The main data recoverer 1406 recovers the main data for providing the main broadcasting service of the broadcasting services to the users, from the main signal, and provides the main broadcasting service to the users.

The first additional signal recoverer 1408 to the N^{th} additional signal recoverer 1412 separate the plurality of respective additional signals from the received broadcasting signal and recover the plurality of additional signals. Here, the first additional signal recoverer 1408 separates and recovers a first additional signal among the plurality of additional signals, from the broadcasting signal, and the N^{th} additional signal recoverer 1412 separates and recovers an N^{th} additional signal among the plurality of additional signals, from the broadcasting signal.

The first additional signal recoverer 1408 to the N^{th} additional signal recoverer 1412 may use the main signal which is outputted from the main signal recoverer 1404, so as to separate and recover the plurality of respective additional signals from the received broadcasting signal. That is to say, the first additional signal recoverer 1408 to the N^{th} additional signal recoverer 1412 may respectively recover the plurality of additional signals from the received broadcasting signal by using the main signal. In FIG. 14, a case of recovering the plurality of respective additional signals from the received broadcasting signal without using the main signal will be mainly described.

The first additional data recoverer 1410 to the N^{th} additional data recoverer 1414 recover the plurality of additional data for providing the various additional services of the broadcasting services to the users, from the plurality of additional signals, and provide the various additional services to the users. Here, the first additional data recoverer 1410 recovers first additional data from the first additional signal and provides a first additional service among the various additional services, and the N^{th} additional data recoverer 1414 recovers N^{th} additional data from the N^{th} additional signal and provides an N^{th} additional service among the various additional services.

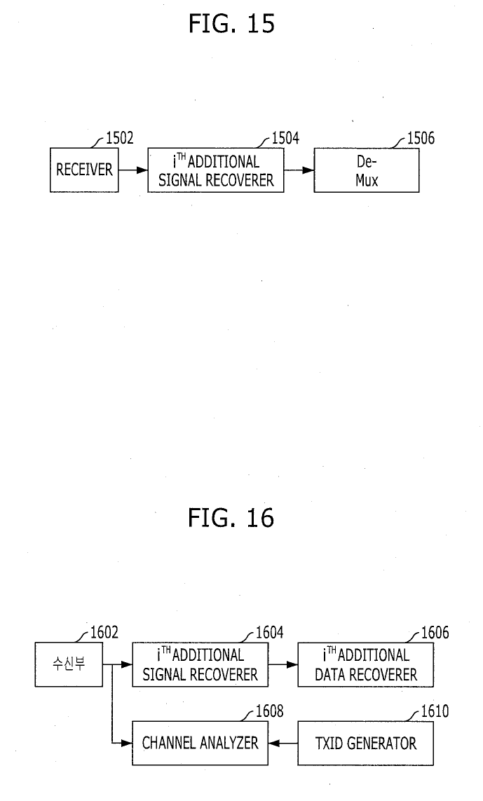

In the data reception apparatus in accordance with the another embodiment of the invention, as the plurality of additional signal recoverers and the plurality of additional data recoverers recover the plurality of additional signals and the plurality of data, from the broadcasting signal in which the main signal of the main data and the plurality of additional signals of the plurality of additional data are coupled with each other, the plurality of additional data corresponding to the various additional services may be simultaneously received as the broadcasting data, and the various additional services may be provided to the users. A data reception apparatus in accordance with another embodiment of the present invention will be described below in detail with reference to FIG. 15.

FIG. 15 is a diagram schematically illustrating the structure of a data reception apparatus in accordance with another exemplary embodiment of the present invention. FIG. 15 is a diagram which schematically illustrates only the components disposed on a path for receiving additional data in the data reception apparatus shown in FIG. 2.

Referring to FIG. 15, the data reception apparatus includes a receiver 1502 configured to receive a broadcasting signal of broadcasting data for providing various types of high definition broadcasting services to users, an i^{th} additional signal recoverer 1504 configured to recover a random i^{th} additional signal among a plurality of additional signals of a plurality of data corresponding to various additional services from the received broadcasting signal, and a De-MUX 1506 configured to demultiplex the i^{th} additional data, recover a plurality of additional data corresponding to the various additional services and provide the various additional services to the users.

The receiver 1502 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 15, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The i^{th} additional signal recoverer 1504 separates the i^{th} additional signal corresponding to the random i^{th} additional service among the various additional services, from the broadcasting signal, and recovers the i^{th} additional signal of the i^{th} additional data. The De-MUX 1506 demultiplexer the i^{th} additional signal, recovers the plurality of additional data for providing the various additional services of the broadcasting services to the users, and provides the various additional services to the users.

The i^{th} additional signal recoverer 1504 may not separate and recover the i^{th} additional signal corresponding to the random i^{th} additional service among the various additional services, from the broadcasting signal, and may separate and recover the plurality of respective additional services corresponding to the various additional services. In this case, while not shown in FIG. 14, the data reception apparatus multiplexes the plurality of additional signals by using a multiplexer, recovers single additional data corresponding to the various additional services, and provides the various additional services to the users.

In the data reception apparatus in accordance with the another embodiment of the invention, as the i^{th} additional signal recoverer 1504 recovers the random i^{th} additional signal from the broadcasting signal in which the main signal of the main data and the plurality of additional signals of the plurality of additional data are coupled with each other and the De-MUX 1506 demultiplexer the random i^{th} additional signal and recovers the plurality of additional data, the plurality of additional data corresponding to the various additional services are simultaneously received as the broadcasting data, and the various additional services are provided to the users. A data reception apparatus in accordance with another embodiment of the present invention will be described below in detail with reference to FIG. 16.

FIG. 16 is a diagram schematically illustrating the structure of a data reception apparatus in accordance with another exemplary embodiment of the present invention. FIG. 16 is a diagram which schematically illustrates only the components disposed on a path for receiving additional data in the data reception apparatus shown in FIG. 2.

Referring to FIG. 16, the data reception apparatus includes a receiver 1602 configured to receive a broadcasting signal of broadcasting data for providing various types of high definition broadcasting services to users, an i^{th} additional signal recoverer 1604 configured to recover a random i^{th} additional signal among a plurality of additional signals of a plurality of data corresponding to various additional services from the received broadcasting signal, an i^{th} additional data recoverer 1606 configured to recover i^{th} additional data corresponding to an i^{th} additional service among the various additional services through the i^{th} additional signal and provide the i^{th} additional service to the users, a TxID generator 1610 configured to generate a TxID signal for analyzing channels when providing the various types of broadcasting services, and a channel analyzer 1608 configured to analyze the broadcasting channels of the received broadcasting signal by using the TxID signal.

The receiver 1602 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 16, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The i^{th} additional signal recoverer 1604 separates the i^{th} additional signal corresponding to the random i^{th} additional service among the various additional services, from the broadcasting signal, and recovers the i^{th} additional signal of the i^{th} additional data. The i^{th} additional data recoverer 1606 recovers the i^{th} additional data for providing the i^{th} additional service among the various additional services of the broadcasting services to the users, from the i^{th} additional signal, and provides the i^{th} additional service to the users.

The TxID generator 1610 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The channel analyzer 1608 analyzes broadcasting channels through which the broadcasting signal is transmitted and received, that is, broadcasting channels through which the various broadcasting services are provided, by using the TxID signal. Accordingly, the data reception apparatus controls a broadcasting network through channel analysis using the TxID signal and efficiently provides the broadcasting services demanded by the users.

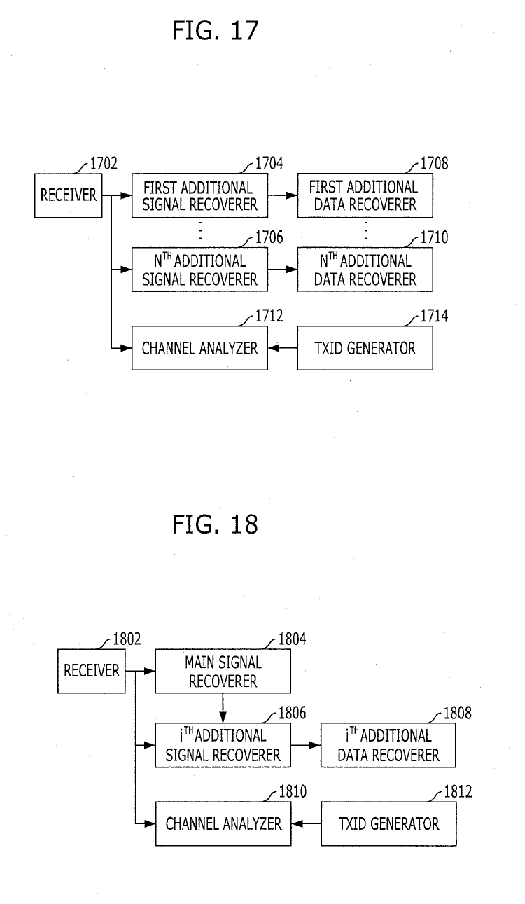

In the data reception apparatus in accordance with the another embodiment of the invention, as the i^{th} additional signal recoverer 1604 and the i^{th} additional data recoverer 1606 recover the random i^{th} additional signal and the random the i^{th} additional data from the broadcasting signal in which the main signal of the main data and the plurality of additional signals of the plurality of additional data are coupled with each other, the plurality of additional data corresponding to the various additional services may be simultaneously received as the broadcasting data. In particular, the i^{th} additional signal and the i^{th} additional data corresponding to the additional service demanded by the users among the various additional services, for example, the random i^{th} additional service, are recovered, and the corresponding additional service demanded by the users is provided to the users. Further, as broadcasting channels through which the various broadcasting services are provided are analyzed using the TxID signal, the data reception apparatus controls a broadcasting network through channel analysis using the TxID signal and efficiently provides the broadcasting services demanded by the users. A data reception apparatus in accordance with another embodiment of the present invention will be described below in detail with reference to FIG. 17.

FIG. 17 is a diagram schematically illustrating the structure of a data reception apparatus in accordance with another exemplary embodiment of the present invention. FIG. 17 is a diagram which schematically illustrates only the components disposed on a path for receiving additional data in the data reception apparatus shown in FIG. 2.

Referring to FIG. 17, the data reception apparatus includes a receiver 1702 configured to receive a broadcasting signal of broadcasting data for providing various types of high definition broadcasting services to users, a plurality of additional signal recoverers, for example, a first additional signal recoverer 1704 to an N^{th} additional signal recoverer 1706, configured to respectively recover a plurality of additional signals of a plurality of data corresponding to various additional services, from the received broadcasting signal, a plurality of additional data recoverers, for example, a first additional data recoverer 1708 to an N^{th} additional data recoverer 1710, configured to respectively recover the plurality of additional data corresponding to the various additional services, through the plurality of additional services, and respectively provide the various additional services to the users, a TxID generator 1714 configured to generate a TxID signal for analyzing channels when providing the various types of broadcasting services, and a channel analyzer 1712 configured to analyze the broadcasting channels of the received broadcasting signal by using the TxID signal.

The receiver 1702 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 17, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The first additional signal recoverer 1704 to the N^{th} additional signal recoverer 1706 separate the plurality of respective additional signals from the received broadcasting signal and recover the plurality of additional signals. Here, the first additional signal recoverer 1704 separates and recovers a first additional signal among the plurality of additional signals, from the broadcasting signal, and the N^{th} additional signal recoverer 1706 separates and recovers an N^{th} additional signal among the plurality of additional signals, from the broadcasting signal.

The first additional data recoverer 1708 to the N^{th} additional data recoverer 1710 recover the plurality of additional data for providing the various additional services of the broadcasting services to the users, from the plurality of additional signals, and provide the various additional services to the users. Here, the first additional data recoverer 1708 recovers first additional data from the first additional signal and provides a first additional service among the various additional services, and the N^{th} additional data recoverer 1710 recovers N^{th} additional data from the N^{th} additional signal and provides an N^{th} additional service among the various additional services.

The TxID generator 1714 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The channel analyzer 1712 analyzes broadcasting channels through which the broadcasting signal is transmitted and received, that is, broadcasting channels through which the various broadcasting services are provided, by using the TxID signal. Accordingly, the data reception apparatus controls a broadcasting network through channel analysis using the TxID signal and efficiently provides the broadcasting services demanded by the users.

In the data reception apparatus in accordance with the another embodiment of the invention, as the plurality of additional signal recoverers and the plurality of additional data recoverers recover the plurality of additional signals and the plurality of data, from the broadcasting signal in which the main signal of the main data and the plurality of additional signals of the plurality of additional data are coupled with each other, the plurality of additional data corresponding to the various additional services may be simultaneously received as the broadcasting data, and the various additional services may be provided to the users. Further, as broadcasting channels through which the various broadcasting services are provided are analyzed using the TxID signal, the data reception apparatus controls a broadcasting network through channel analysis using the TxID signal and efficiently provides the broadcasting services demanded by the users. A data reception apparatus in accordance with another embodiment of the present invention will be described below in detail with reference to FIG. 18.

FIG. 18 is a diagram schematically illustrating the structure of a data reception apparatus in accordance with another exemplary embodiment of the present invention.

Referring to FIG. 18, the data reception apparatus includes a receiver 1802 configured to receive a broadcasting signal of broadcasting data for providing various types of high definition broadcasting services to users, a main signal recoverer 1804 configured to recover a main signal of main data corresponding to a main broadcasting service, from the received broadcasting signal, an i^{th} additional signal recoverer 1806 configured to recover a random i^{th} additional signal among a plurality of additional signals of a plurality of data corresponding to various additional services from the received broadcasting signal, by using the main signal, and an i^{th} additional data recoverer 1808 configured to recover i^{th} additional data corresponding to an i^{th} additional service among the various additional services through the i^{th} additional signal and provide the i^{th} additional service to the users, a TxID generator 1812 configured to generate a TxID signal for analyzing channels when providing the various types of broadcasting services, and a channel analyzer 1810 configured to analyze the broadcasting channels of the received broadcasting signal by using the TxID signal.

The receiver 1802 receives the broadcasting signal as the broadcasting data corresponding to the broadcasting services to be provided to the users. As aforementioned above, the broadcasting signal is a signal in which the main signal of the main data corresponding to the main broadcasting service and the plurality of additional signals of the plurality of additional data corresponding to the various additional services are coupled with each other.

The data reception apparatus includes the main signal recoverer 1804 configured to recover the main signal of the main data corresponding to the main broadcasting service, from the received broadcasting signal, and a main data recoverer (not shown in FIG. 18) configured to recover the main data corresponding to the main broadcasting service, from the main signal. The main signal recoverer 1804 separates the main signal from the broadcasting signal and recovers the main signal of the main data. The main data recoverer recovers the main data for providing the main broadcasting service of the broadcasting services to the users, from the main signal, and provides the main broadcasting service to the users.

The i^{th} additional signal recoverer 1806 separates the i^{th} additional signal corresponding to the random i^{th} additional service among the various additional services, from the broadcasting signal by using the main signal, and recovers the i^{th} additional signal of the i^{th} additional data. The i^{th} additional data recoverer 1808 recovers the i^{th} additional data for providing the i^{th} additional service among the various additional services of the broadcasting services to the users, from the i^{th} additional signal, and provides the i^{th} additional service to the users.

The TxID generator 1812 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The channel analyzer 1810 analyzes broadcasting channels through which the broadcasting signal is transmitted and received, that is, broadcasting channels through which the various broadcasting services are provided, by using the TxID signal. Accordingly, the data reception apparatus controls a broadcasting network through channel analysis using the TxID signal and efficiently provides the broadcasting services demanded by the users.

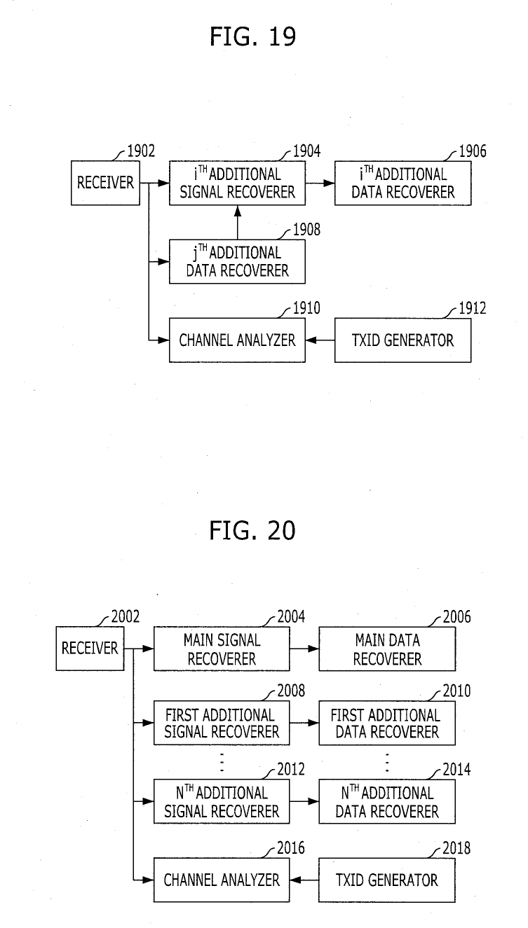

In the data reception apparatus in accordance with the another embodiment of the invention, as the i^{th} additional signal recoverer 1806 and the i^{th} additional data recoverer 1808 recover the random i^{th} additional signal and the random the i^{th} additional data from the broadcasting signal in which the main signal of the main data and the plurality of additional signals of the plurality of additional data are coupled with each other, by using the main signal, the plurality of additional data corresponding to the various additional services may be simultaneously received as the broadcasting data. In particular, the i^{th} additional signal and the i^{th} additional data corresponding to the additional service demanded by the users among the various additional services, for example, the random i^{th} additional service, are recovered, and the corresponding additional service demanded by the users is provided to the users. Further, as broadcasting channels through which the various broadcasting services are provided are analyzed using the TxID signal, the data reception apparatus controls a broadcasting network through channel analysis using the TxID signal and efficiently provides the broadcasting services demanded by the users. A data reception apparatus in accordance with another embodiment of the present invention will be described below in detail with reference to FIG. 19.

FIG. 19 is a diagram schematically illustrating the structure of a data reception apparatus in accordance with another exemplary embodiment of the present invention. FIG. 19 is a diagram which schematically illustrates only the components disposed on a path for receiving additional data in the data reception apparatus shown in FIG. 2.

Referring to FIG. 19, the data reception apparatus includes a receiver 1902 configured to receive a broadcasting signal of broadcasting data for providing various types of high definition broadcasting services to users, an j^{th} additional signal recoverer 1908 configured to recover a random j^{th} additional signal among a plurality of additional signals of a plurality of data corresponding to various additional services from the received broadcasting signal, an i^{th} additional signal recoverer 1904 configured to recover a random i^{th} additional signal among the plurality of additional signals of the plurality of data corresponding to the various additional services from the received broadcasting signal, by using the random j^{th} additional signal, an i^{th} additional data recoverer 1906 configured to recover i^{th} additional data corresponding to an i^{th} additional service among the various additional services through the i^{th} additional signal and provide the i^{th} additional service to the users, a TxID generator 1912 configured to generate a TxID signal for analyzing channels when providing the various types of broadcasting services, and a channel analyzer 1910 configured to analyze the broadcasting channels of the received broadcasting signal by using the TxID signal.

The receiver 1902 receives the broadcasting signal as the broadcasting data corresponding to the broadcasting services to be provided to the users. The broadcasting signal is a signal in which a main signal of main data corresponding to a main broadcasting service and the plurality of additional signals of the plurality of additional data corresponding to the various additional services are coupled with each other.

While not shown in FIG. 19, the data reception apparatus includes a main signal recoverer configured to recover the main signal of the main data corresponding to the main broadcasting service, from the received broadcasting signal, and a main data recoverer configured to recover the main data corresponding to the main broadcasting service, from the main signal. The main signal recoverer separates the main signal from the broadcasting signal and recovers the main signal of the main data. The main data recoverer recovers the main data for providing the main broadcasting service of the broadcasting services to the users, from the main signal, and provides the main broadcasting service to the users. In the case where the users want to receive only the various additional services, that is, only the additional data are received, operations for recovering the main signal from the broadcasting signal and recovering the main data may not be performed selectively.

The j^{th} additional signal recoverer 1908 separates the j^{th} additional signal corresponding to the random j^{th} additional service among the various additional services, from the broadcasting signal, and recovers the j^{th} additional signal of the j^{th} additional data. In other words, the j^{th} additional data recoverer 1908 separates and recovers the random j^{th} additional data among the plurality of additional signals included in the broadcasting signal.

The i^{th} additional signal recoverer 1904 separates the i^{th} additional signal corresponding to the random i^{th} additional service among the various additional services, from the broadcasting signal, by using the random j^{th} additional signal, and recovers the i^{th} additional signal of the i^{th} additional data. The i^{th} additional data recoverer 1906 recovers the i^{th} additional data for providing the i^{th} additional service among the various additional services of the broadcasting services to the users, from the i^{th} additional signal, and provides the i^{th} additional service to the users.

The TxID generator 1912 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The channel analyzer 1910 analyzes broadcasting channels through which the broadcasting signal is transmitted and received, that is, broadcasting channels through which the various broadcasting services are provided, by using the TxID signal. Accordingly, the data reception apparatus controls a broadcasting network through channel analysis using the TxID signal and efficiently provides the broadcasting services demanded by the users.

In the data reception apparatus in accordance with the another embodiment of the invention, as the j^{th} additional signal recoverer 1908 recovers the random j^{th} additional signal from the broadcasting signal in which the main signal of the main data and the plurality of additional signals of the plurality of additional data are coupled with each other and the i^{th} additional signal recoverer 1904 and the i^{th} additional data recoverer 1906 recover the random i^{th} additional signal and the random the i^{th} additional data from the broadcasting signal in which the main signal of the main data and the plurality of additional signals of the plurality of additional data are coupled with each other, by using the random j^{th} additional signal, the plurality of additional data corresponding to the various additional services may be simultaneously received as the broadcasting data. In particular, the i^{th} additional signal and the i^{th} additional data corresponding to the additional service demanded by the users among the various additional services, for example, the random i^{th} additional service, are recovered, and the corresponding additional service demanded by the users is provided to the users. Further, as broadcasting channels through which the various broadcasting services are provided are analyzed using the TxID signal, the data reception apparatus controls a broadcasting network through channel analysis using the TxID signal and efficiently provides the broadcasting services demanded by the users. A data reception apparatus in accordance with another embodiment of the present invention will be described below in detail with reference to FIG. 20.

FIG. 20 is a diagram schematically illustrating the structure of a data reception apparatus in accordance with another exemplary embodiment of the present invention.

Referring to FIG. 20, the data reception apparatus includes a receiver 2002 configured to receive a broadcasting signal of broadcasting data for providing various types of high definition broadcasting services to users, a main signal recoverer 2004 configured to recover a main signal of main data corresponding to a main broadcasting service, from the received broadcasting signal, a main data recoverer 2006 configured to recover the main data corresponding to the main broadcasting service, from the main signal, and provide the main broadcasting service to the users, a plurality of additional signal recoverers, for example, a first additional signal recoverer 2008 to an N^{th} additional signal recoverer 2012, configured to respectively recover a plurality of additional signals of a plurality of data corresponding to various additional services, from the received broadcasting signal, a plurality of additional data recoverers, for example, a first additional data recoverer 2010 to an N^{th} additional data recoverer 2014, configured to respectively recover the plurality of additional data corresponding to the various additional services, through the plurality of additional services, and respectively provide the various additional services to the users, a TxID generator 2018 configured to generate a TxID signal for analyzing channels when providing the various types of broadcasting services, and a channel analyzer 2016 configured to analyze the broadcasting channels of the received broadcasting signal by using the TxID signal.

The receiver 2002 receives the broadcasting signal as the broadcasting data corresponding to the broadcasting services to be provided to the users. As aforementioned above, the broadcasting signal is a signal in which the main signal of the main data corresponding to the main broadcasting service and the plurality of additional signals of the plurality of additional data corresponding to the various additional services are coupled with each other.

The main signal recoverer 2004 separates the main signal from the broadcasting signal and recovers the main signal of the main data. The main data recoverer 1406 recovers the main data for providing the main broadcasting service of the broadcasting services to the users, from the main signal, and provides the main broadcasting service to the users.

The first additional signal recoverer 2008 to the N^{th} additional signal recoverer 2012 separate the plurality of respective additional signals from the received broadcasting signal and recover the plurality of additional signals. Here, the first additional signal recoverer 2008 separates and recovers a first additional signal among the plurality of additional signals, from the broadcasting signal, and the N^{th} additional signal recoverer 2012 separates and recovers an N^{th} additional signal among the plurality of additional signals, from the broadcasting signal.

The first additional signal recoverer 2008 to the N^{th} additional signal recoverer 2012 may use the main signal which is outputted from the main signal recoverer 2004, so as to separate and recover the plurality of respective additional signals from the received broadcasting signal. That is to say, the first additional signal recoverer 2008 to the N^{th} additional signal recoverer 2012 may respectively recover the plurality of additional signals from the received broadcasting signal by using the main signal. In FIG. 20, a case of recovering the plurality of respective additional signals from the received broadcasting signal without using the main signal will be mainly described.

The first additional data recoverer 2010 to the N^{th} additional data recoverer 2014 recover the plurality of additional data for providing the various additional services of the broadcasting services to the users, from the plurality of additional signals, and provide the various additional services to the users. Here, the first additional data recoverer 2010 recovers first additional data from the first additional signal and provides a first additional service among the various additional services, and the N^{th} additional data recoverer 2014 recovers N^{th} additional data from the N^{th} additional signal and provides an N^{th} additional service among the various additional services.

The TxID generator 2018 generates the TxID signal used when analyzing broadcasting channels through which the broadcasting data are transmitted and received, when transmitting and receiving the broadcasting data corresponding to the broadcasting services to provide the users with the various types of broadcasting services demanded by the users. The TxID signal is a signal which is transmitted and received together with broadcasting data of a corresponding broadcasting service in the various types of broadcasting services demanded by the users. The TxID signal is used when analyzing a transmitter for transmitting the broadcasting data of the corresponding broadcasting service and a broadcasting channel used by the transmitter, that is, a broadcasting channel through which the broadcasting data of the corresponding broadcasting service is transmitted and received.

The channel analyzer 2016 analyzes broadcasting channels through which the broadcasting signal is transmitted and received, that is, broadcasting channels through which the various broadcasting services are provided, by using the TxID signal. Accordingly, the data reception apparatus controls a broadcasting network through channel analysis using the TxID signal and efficiently provides the broadcasting services demanded by the users.

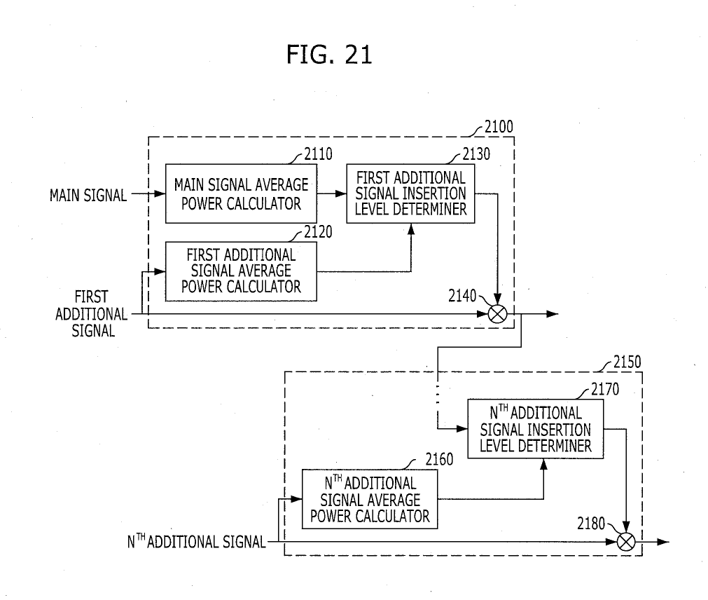

In the data reception apparatus in accordance with the another embodiment of the invention, as the plurality of additional signal recoverers and the plurality of additional data recoverers recover the plurality of additional signals and the plurality of data, from the broadcasting signal in which the main signal of the main data and the plurality of additional signals of the plurality of additional data are coupled with each other, the plurality of additional data corresponding to the various additional services may be simultaneously received as the broadcasting data, and the various additional services may be provided to the users. Further, as broadcasting channels through which the various broadcasting services are provided are analyzed using the TxID signal, the data reception apparatus controls a broadcasting network through channel analysis using the TxID signal and efficiently provides the broadcasting services demanded by the users. A power controller of a data transmission apparatus in a communication system in accordance with another embodiment of the present invention will be described below in detail with reference to FIGS. 21 to 25.

FIG. 21 is a diagram schematically illustrating the structure of a power controller of a data transmission apparatus in a communication system in accordance with an exemplary embodiment of the present invention.

Referring to FIG. 21, as described above, the power controller includes a plurality of power controllers for respectively controlling the average power of a plurality of additional signals, for example, a first power controller 2100 to an N^{th} power controller 2150. As described above, the first power controller 2100 to the N^{th} power controller 2150 control the power of a first additional signal to an N^{th} additional signal depending upon the power level of a main signal, for example, to power levels lower than the power level of the main signal, so as to prevent the plurality of additional signals from exerting an influence on the main signal.

The first power controller 2100 includes a main signal average power calculator 2110 configured to calculate the average power of the main signal, a first additional signal average power calculator 2120 configured to calculate the average power of the first additional signal among the plurality of additional signals, a first additional signal insertion level determiner 2130 configured to compare the average power of the main signal with the average power of the first additional signal and determine an insertion level, that is, an average power control value of the first additional signal, and a first multiplier 2140 configured to multiply the first additional signal by the average power control value of the first additional signal and control the average power of the first additional signal.

The N^{th} power controller 2150 includes an N^{th} additional signal average power calculator 2160 configured to calculate the average power of the N^{th} additional signal among the plurality of additional signals, an N^{th} additional signal insertion level determiner 2170 configured to compare the average power of a previous additional signal of the N^{th} additional signal, that is, an (N−1)^{th} additional signal, among the plurality of additional signal with the average power of the N^{th} additional signal and determine an insertion level, that is, an average power control value of the N^{th} additional signal, and an N^{th} multiplier 2180 configured to multiply the N^{th} additional signal by the average power control value of the N^{th} additional signal and control the average power of the N^{th} additional signal.

The first additional signal insertion level determiner 2130 compares the average power of the main signal with the average power of the first additional signal and determines the average power control value of the first additional signal such that the power level of the first additional signal is lower than the power level of the main signal. Accordingly, the first multiplier 2140 multiplies the first additional signal by the average power control value of the first additional signal and outputs the first additional signal with the power level lower than the power level of the main signal to a coupler.

While not shown in FIG. 21, a second power controller for controlling the average power of a second additional signal next to the first additional signal includes a second additional signal average power calculator, a second additional signal insertion level determiner and a second multiplier, similar to the N^{th} power controller 2150. The second additional signal average power calculator is configured to calculate the average power of the second additional signal. The second additional signal insertion level determiner is configured to compare the average power of the second additional signal with the average power of the first additional signal, of which average power is controlled to the power level lower than the power level of the main signal, and determine an average power control value of the second additional signal. The second additional signal insertion level determiner determines the average power control value of the second additional signal such that the power level of the second additional signal is lower than the power level of the first additional signal of which average power is controlled to the power level lower than the power level of the main signal. Accordingly, the second multiplier is configured to multiply the second additional signal by the average power control value of the second additional signal and outputs the second additional signal with the power level lower than the power level of the first additional signal controlled in the average power thereof, to the coupler.

In the N^{th} power controller 2150, the N^{th} additional signal average power calculator 2160 calculates the average power of the N^{th} additional signal, and the N^{th} additional signal insertion level determiner 2170 compares the average power of the N^{th} additional signal with the average power of the (N−1)^{th} additional signal controlled in the average power thereof and determines the average power control value of the N^{th} additional signal. The N^{th} additional signal insertion level determiner 2170 determines the average power control value such that the power level of the N^{th} additional signal is lower than the power level of the (N−1)^{th} additional signal controlled in the average power thereof. Accordingly, the N^{th} multiplier 2180 multiplies the N^{th} additional signal by the average power control value of the N^{th} additional signal and outputs the N^{th} additional signal with the power level lower than the power level of the (N−1)^{th} additional signal controlled in the average power thereof, to the coupler.

While it was described that power levels of additional signals next to the first additional signal are controlled to be lower than power levels of respective previous signals, it is conceivable that the power levels of the additional signals next to the first additional signal may be controlled to be the same as or higher than the power levels of the respective previous signals. At this time, the average power levels of all the plurality of additional signals are controlled to be lower than the power level of the main signal.

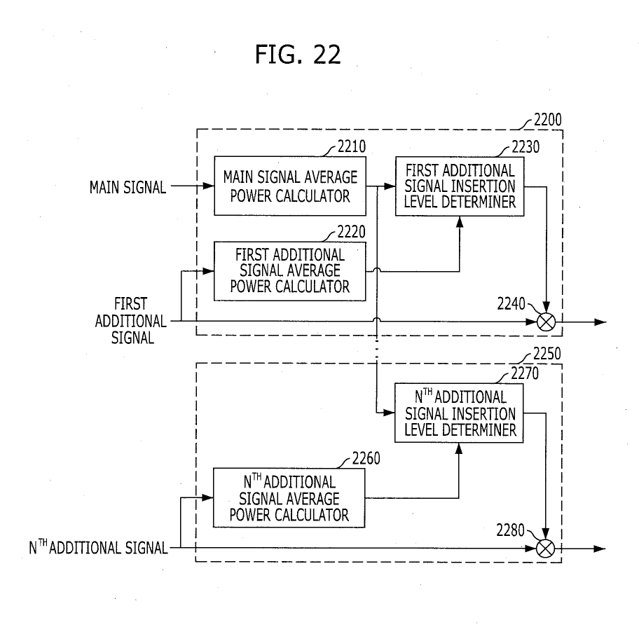

In the power controller in accordance with the another embodiment of the invention, the plurality of power controllers, that is, the first power controller 2100 to the N^{th} power controller 2150 control the average power of the plurality of additional signals to levels lower than the power level of the main signal. In particular, the first power controller 2100 compares the average power of the main signal with the average power of the first additional signal and controls the average power of the first additional signal. The remaining power controllers, for example, the second power controller to the N^{th} power controller 2150 compare the average power of corresponding additional signals with the average power of previous additional signals controlled in the average power thereof and control the average power of the corresponding additional signals. A power controller in accordance with another embodiment of the present invention will be described below in detail with reference to FIG. 22.

FIG. 22 is a diagram schematically illustrating the structure of a power controller in accordance with another exemplary embodiment of the present invention.

Referring to FIG. 22, as described above, the power controller includes a plurality of power controllers for respectively controlling the average power of a plurality of additional signals, for example, a first power controller 2200 to an N^{th} power controller 2250. As described above, the first power controller 2200 to the N^{th} power controller 2250 control the power of a first additional signal to an N^{th} additional signal depending upon the power level of a main signal, for example, to power levels lower than the power level of the main signal, so as to prevent the plurality of additional signals from exerting an influence on the main signal.

The first power controller 2200 includes a main signal average power calculator 2210 configured to calculate the average power of the main signal, a first additional signal average power calculator 2220 configured to calculate the average power of the first additional signal among the plurality of additional signals, a first additional signal insertion level determiner 2230 configured to compare the average power of the main signal with the average power of the first additional signal and determine an insertion level, that is, an average power control value of the first additional signal, and a first multiplier 2240 configured to multiply the first additional signal by the average power control value of the first additional signal and control the average power of the first additional signal.

The N^{th} power controller 2250 includes an N^{th} additional signal average power calculator 2260 configured to calculate the average power of the N^{th} additional signal among the plurality of additional signals, an N^{th} additional signal insertion level determiner 2270 configured to compare the average power of the main signal calculated by the main signal average power calculator 2210 of the first power controller 2200 with the average power of the N^{th} additional signal and determine an insertion level, that is, an average power control value of the N^{th} additional signal, and an N^{th} multiplier 2280 configured to multiply the N^{th} additional signal by the average power control value of the N^{th} additional signal and control the average power of the N^{th} additional signal.

The first additional signal insertion level determiner 2230 compares the average power of the main signal with the average power of the first additional signal and determines the average power control value of the first additional signal such that the power level of the first additional signal is lower than the power level of the main signal. Accordingly, the first multiplier 2240 multiplies the first additional signal by the average power control value of the first additional signal and outputs the first additional signal with the power level lower than the power level of the main signal to a coupler.

In the N^{th} power controller 2250, the N^{th} additional signal average power calculator 2260 calculates the average power of the N^{th} additional signal, and the N^{th} additional signal insertion level determiner 2270 compares the average power of the main signal with the average power of the N^{th} additional signal and determines the average power control value of the N^{th} additional signal. The N^{th} additional signal insertion level determiner 2270 determines the average power control value such that the power level of the N^{th} additional signal is lower than the power level of the main signal. Accordingly, the N^{th} multiplier 2280 multiplies the N^{th} additional signal by the average power control value of the N^{th} additional signal and outputs the N^{th} additional signal with the power level lower than the power level of the main signal to the coupler.

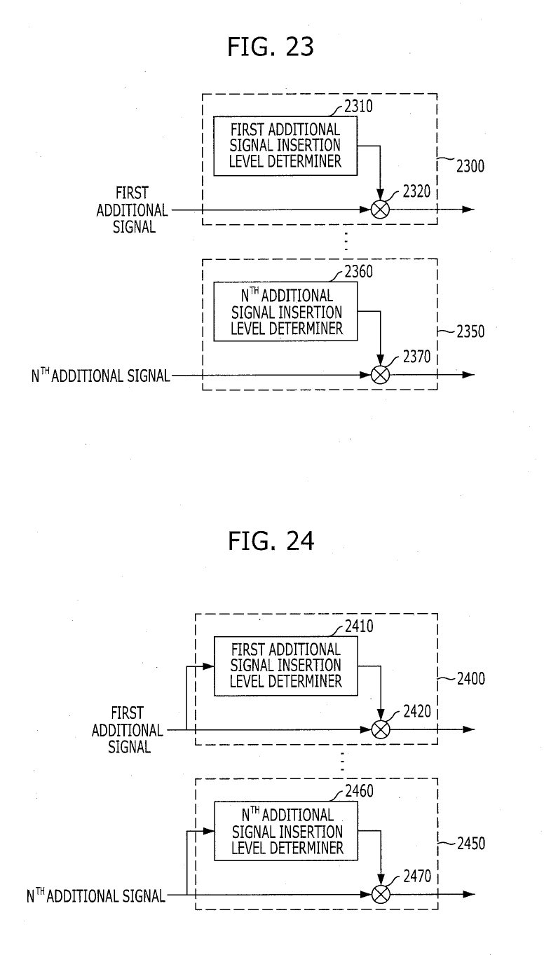

In the power controller in accordance with the another embodiment of the invention, the plurality of power controllers, that is, the first power controller 2200 to the N^{th} power controller 2250 control the average power of the plurality of additional signals to levels lower than the power level of the main signal. In particular, the first power controller 2200 calculates and compares the average power of the main signal and the average power of the first additional signal and controls the average power of the first additional signal. The remaining power controllers, for example, the second power controller to the N^{th} power controller 2250 calculate the average power of corresponding additional signals, compare the average power of the main signal with the average power of the corresponding additional signals, and control the average power of the corresponding additional signals. A power controller in accordance with another embodiment of the present invention will be described below in detail with reference to FIG. 23.

FIG. 23 is a diagram schematically illustrating the structure of a power controller in accordance with another exemplary embodiment of the present invention.

Referring to FIG. 23, as described above, the power controller includes a plurality of power controllers for respectively controlling the average power of a plurality of additional signals, for example, a first power controller 2300 to an N^{th} power controller 2350. As described above, the first power controller 2300 to the N^{th} power controller 2350 control the power of a first additional signal to an N^{th} additional signal depending upon the power level of a main signal, for example, to power levels lower than the power level of the main signal, so as to prevent the plurality of additional signals from exerting an influence on the main signal.

The first power controller 2300 includes a first additional signal insertion level determiner 2310 configured to determine an average power control value of the first additional signal to a preset insertion level, and a first multiplier 2320 configured to multiply the first additional signal by the average power control value of the first additional signal and control the average power of the first additional signal. The preset insertion level is set such that the first additional signal has a power level lower than the power level of the main signal. The first additional signal insertion level determiner 2310 determines the average power control value of the first additional signal according to the preset insertion level such that the power level of the first additional signal is lower than the power level of the main signal. Accordingly, the first multiplier 2320 multiplies the first additional signal by the average power control value of the first additional signal and outputs the first additional signal with the power level lower than the power level of the main signal to a coupler.

The N^{th} power controller 2350 includes an N^{th} additional signal insertion level determiner 2360 configured to determine an average power control value of the N^{th} additional signal to a preset insertion level, and an N^{th} multiplier 2370 configured to multiply the N^{th} additional signal by the average power control value of the N^{th} additional signal and control the average power of the N^{th} additional signal. As described above, the preset insertion level is set such that the N^{th} additional signal has a power level lower than the power level of the main signal. The N^{th} additional signal insertion level determiner 2360 determines the average power control value of the N^{th} additional signal according to the preset insertion level such that the power level of the N^{th} additional signal is lower than the power level of the main signal. Accordingly, the N^{th} multiplier 2370 multiplies the N^{th} additional signal by the average power control value of the N^{th} additional signal and outputs the N^{th} additional signal with the power level lower than the power level of the main signal to the coupler.

In the power controller in accordance with the another embodiment of the invention, the plurality of power controllers, that is, the first power controller 2300 to the N^{th} power controller 2350 control the average power of the plurality of additional signals to levels lower than the power level of the main signal. In particular, the first power controller 2300 to the N^{th} power controller 2350 control the average power of the plurality of additional signals to the power levels lower than the power level of the main signal, according to the preset insertion levels that are set such that the power levels of the plurality of additional signals become lower than the power level of the main signal. A power controller in accordance with another embodiment of the present invention will be described below in detail with reference to FIG. 24.

FIG. 24 is a diagram schematically illustrating the structure of a power controller in accordance with another exemplary embodiment of the present invention.

Referring to FIG. 24, as described above, the power controller includes a plurality of power controllers for respectively controlling the average power of a plurality of additional signals, for example, a first power controller 2400 to an N^{th} power controller 2450. As described above, the first power controller 2400 to the N^{th} power controller 2450 control the power of a first additional signal to an N^{th} additional signal depending upon the power level of a main signal, for example, to power levels lower than the power level of the main signal, so as to prevent the plurality of additional signals from exerting an influence on the main signal.

The first power controller 2400 includes a first additional signal insertion level determiner 2410 configured to determine an average power control value of the first additional signal to a preset insertion level in consideration of the power level of the first additional signal, and a first multiplier 2420 configured to multiply the first additional signal by the average power control value of the first additional signal and control the average power of the first additional signal. The preset insertion level is set such that the first additional signal has a power level lower than the power level of the main signal. The first additional signal insertion level determiner 2410 determines the average power control value of the first additional signal according to the preset insertion level in consideration of the power level of the first additional signal such that the power level of the first additional signal is lower than the power level of the main signal. Accordingly, the first multiplier 2420 multiplies the first additional signal by the average power control value of the first additional signal and outputs the first additional signal with the power level lower than the power level of the main signal to a coupler.

The N^{th} power controller 2450 includes an N^{th} additional signal insertion level determiner 2460 configured to determine an average power control value of the N^{th} additional signal to a preset insertion level in consideration of the power level of the N^{th} additional signal, and an N^{th} multiplier 2470 configured to multiply the N^{th} additional signal by the average power control value of the N^{th} additional signal and control the average power of the N^{th} additional signal. The preset insertion level is set such that the N^{th} additional signal has a power level lower than the power level of the main signal. The N^{th} additional signal insertion level determiner 2460 determines the average power control value of the N^{th} additional signal according to the preset insertion level in consideration of the power level of the N^{th} additional signal such that the power level of the N^{th} additional signal is lower than the power level of the main signal. Accordingly, the N^{th} multiplier 2470 multiplies the N^{th} additional signal by the average power control value of the N^{th} additional signal and outputs the N^{th} additional signal with the power level lower than the power level of the main signal to the coupler.

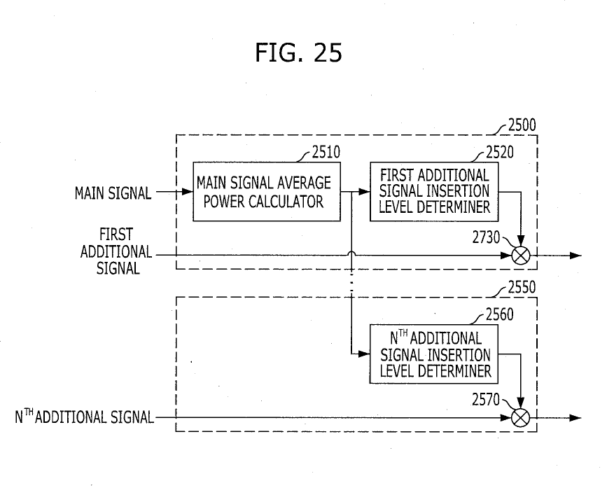

In the power controller in accordance with the another embodiment of the invention, the plurality of power controllers, that is, the first power controller 2400 to the N^{th} power controller 2450 control the average power of the plurality of additional signals to levels lower than the power level of the main signal. In particular, the first power controller 2400 to the N^{th} power controller 2450 control the average power of the plurality of additional signals to the power levels lower than the power level of the main signal, according to the preset insertion levels that are set such that the power levels of the plurality of additional signals become lower than the power level of the main signal, in consideration of the power levels of the plurality of additional signals. A power controller in accordance with another embodiment of the present invention will be described below in detail with reference to FIG. 25.

FIG. 25 is a diagram schematically illustrating the structure of a power controller in accordance with another exemplary embodiment of the present invention.

Referring to FIG. 25, as described above, the power controller includes a plurality of power controllers for respectively controlling the average power of a plurality of additional signals, for example, a first power controller 2500 to an N^{th} power controller 2550. As described above, the first power controller 2500 to the N^{th} power controller 2550 control the power of a first additional signal to an N^{th} additional signal depending upon the power level of a main signal, for example, to power levels lower than the power level of the main signal, so as to prevent the plurality of additional signals from exerting an influence on the main signal.

The first power controller 2500 includes a main signal average power calculator 2510 configured to calculate the average power of the main signal, a first additional signal insertion level determiner 2520 configured to determine an average power control value of the first additional signal to a preset insertion level in consideration of the average power of the main signal, and a first multiplier 2530 configured to multiply the first additional signal by the average power control value of the first additional signal and control the average power of the first additional signal. The preset insertion level is set such that the first additional signal has a power level lower than the power level of the main signal. The first additional signal insertion level determiner 2520 determines the average power control value of the first additional signal according to the preset insertion level in consideration of the average power of the main signal such that the power level of the first additional signal is lower than the power level of the main signal. Accordingly, the first multiplier 2530 multiplies the first additional signal by the average power control value of the first additional signal and outputs the first additional signal with the power level lower than the power level of the main signal to a coupler.

The N^{th} power controller 2550 includes an N^{th} additional signal insertion level determiner 2560 configured to determine an average power control value of the N^{th} additional signal to a preset insertion level in consideration of the average power of the main signal, and an N^{th} multiplier 2570 configured to multiply the N^{th} additional signal by the average power control value of the N^{th} additional signal and control the average power of the N^{th} additional signal. The preset insertion level is set such that the N^{th} additional signal has a power level lower than the power level of the main signal. The N^{th} additional signal insertion level determiner 2560 determines the average power control value of the N^{th} additional signal according to the preset insertion level in consideration of the average power of the main signal such that the power level of the N^{th} additional signal is lower than the power level of the main signal. Accordingly, the N^{th} multiplier 2570 multiplies the N^{th} additional signal by the average power control value of the N^{th} additional signal and outputs the N^{th} additional signal with the power level lower than the power level of the main signal to the coupler.

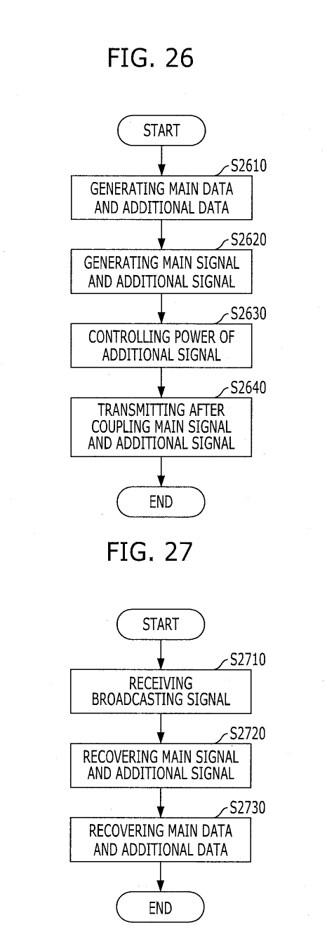

In the power controller in accordance with the another embodiment of the invention, the plurality of power controllers, that is, the first power controller 2500 to the N^{th} power controller 2550 control the average power of the plurality of additional signals to levels lower than the power level of the main signal. In particular, the first power controller 2500 to the N^{th} power controller 2550 control the average power of the plurality of additional signals to the power levels lower than the power level of the main signal, according to the preset insertion levels that are set such that the power levels of the plurality of additional signals become lower than the power level of the main signal, in consideration of the average power of the main signal. Data transmitting operations of a data transmission apparatus in a communication system in accordance with another embodiment of the present invention will be described below in detail with reference to FIG. 26.

FIG. 26 is a flow chart schematically showing an operating procedure of a data transmission apparatus in a communication system in accordance with an exemplary embodiment of the present invention.

Referring to FIG. 26, at step 2610, in order to provide various types of high definition broadcasting services to users, the data transmission apparatus generates main data corresponding to a main broadcasting service of the broadcasting services, and in order to provide various additional services in broadcasting services in conformity with users' various demands for various additional services, the data transmission apparatus generates a plurality of additional data corresponding to the various additional services of the broadcasting services.

At step 2620, a baseband main signal for the main data and baseband additional signals for the plurality of additional data are generated. Since the generation of the plurality of additional data and the plurality of additional signals are described above in detail, detailed descriptions thereof will be omitted herein.

Next, at step 2630, the average power of the plurality of additional signals is respectively controlled in such a manner that the plurality of additional signals do not exert any influence on the main signal. The plurality of additional signals are controlled to have power levels lower than a power level of the main signal. Since the control of the power levels is described above in detail, detailed descriptions thereof will be omitted herein.

Then, at step 2640, a broadcasting signal is generated by coupling the main signal with the plurality of additional signals controlled in the average power levels thereof. Thereafter, the broadcasting signal, that is, broadcasting data is transmitted. At this time, in order to analyze broadcasting channels through which the broadcasting signal is transmitted and received, as described above, a TxID signal is generated. After controlling the average power of the TxID signal, the TxID signal may be coupled with the main signal and the plurality of additional signals. That is to say, the TxID signal may be transmitted by being coupled with the broadcasting signal. Data receiving operations of a data reception apparatus in a communication system in accordance with another embodiment of the present invention will be described below in detail with reference to FIG. 27.

FIG. 27 is a flow chart schematically showing an operating procedure of a data reception apparatus in a communication system in accordance with an exemplary embodiment of the present invention.

Referring to FIG. 27, at step 2710, the data reception apparatus receives a broadcasting signal of broadcasting data for providing various types of high definition broadcasting services to users. In the broadcasting signal, a main signal of main data corresponding to a main broadcasting service in the broadcasting services and a plurality of additional signals of a plurality of additional data corresponding to various additional services in the broadcasting services are coupled with each other, and a TxID signal for analysis of broadcasting channels may also be coupled.

Next, at step 2720, the main signal is recovered by separating the main signal of the main data corresponding to the main broadcasting service, from the received broadcasting signal, and the plurality of additional signals are recovered by separating the plurality of additional signals of the plurality of additional data corresponding to the various additional services, from the received broadcasting signal. Since the recovery of the plurality of additional signals is described above in detail, detailed description thereof will be omitted herein.

Then, at step 2730, the main broadcasting service is provided to the users by recovering the main data corresponding to the main broadcasting service through the main signal, and the various additional services are provided to the users by recovering the plurality of additional data corresponding to the various additional services through the plurality of additional signals. By analyzing the broadcasting channels through which the broadcasting signal is transmitted and received, using the TxID signal, the data reception apparatus may control a broadcasting network through the channel analysis using the TxID signal and may efficiently provide the broadcasting services demanded by the users.

As is apparent from the above descriptions, in the data transmission and reception apparatuses of a communication system in accordance with the embodiments of the present invention, in order to provide various types of high definition broadcasting services to users and in order to provide various additional services in the broadcasting services in conformity with users' various demands for various additional services, main data corresponding to a main broadcasting service of the broadcasting services, and a plurality of additional data and a plurality of additional signals corresponding to the various additional services of the broadcasting services are simultaneously transmitted and received, whereby the data transmission rate of the system can be improved. Also, by analyzing channels through which broadcasting data are transmitted and received, using a TxID (transmitter identification) signal, the data reception apparatus may control a broadcasting network through the channel analysis using the TxID signal and may efficiently provide the broadcasting services demanded by the users.

In the embodiments of the present invention, the main data corresponding to the main broadcasting service of the high definition broadcasting services demanded by the users are coupled with the plurality of additional data corresponding to the various additional services of the broadcasting services so that the broadcasting data corresponding to the broadcasting services may be transmitted and received, whereby the transmission efficiency of the broadcasting data can be improved and not only the high definition broadcasting services but also the various additional services of the broadcasting services demanded by the users can be stably provided to the users.

Furthermore, in the embodiments of the present invention, the TxID signal is used when transmitting and receiving the broadcasting data in which the main data and the plurality of additional data are coupled with each other, so that a broadcasting network can be controlled through analyzing the channels of the broadcasting data, that is, through analyzing the channels of the broadcasting data using the TxID signal, whereby the broadcasting services demanded by the users can be efficiently provided.

While the present invention has been described with respect to the specific embodiments, it will be apparent to those skilled in the art that various changes and modifications may be made without departing from the spirit and scope of the invention as defined in the following claims.

What is claimed is:

1. A data transmission apparatus of a communication system, comprising:
a main data generator configured to generate main data corresponding to a main broadcasting service of broadcasting services;
a main signal generator configured to generate a main signal of the main data;
an additional data generator configured to generate a plurality of additional data corresponding to various additional services of the broadcasting services;
an additional signal generator configured to generate a plurality of additional signals of the plurality of additional data;
a power controller configured to control average power of the plurality of additional signals;
a coupler configured to couple the main signal and the plurality of additional signals controlled in the average power thereof, and generate a broadcasting signal; and
a transmitter configured to transmit the broadcasting signal.

2. The data transmission apparatus of claim 1, further comprising:
a multiplexer configured to multiplex the plurality of additional data and generate a signal additional signal,
wherein the power controller controls an average power level of the single additional signal, and
wherein the coupler couples the main signal and the single additional signal controlled in average power thereof and generates the broadcasting signal.

3. The data transmission apparatus of claim 1,
wherein the additional data generator generates single additional data corresponding to the various additional services of the broadcasting services, and
wherein the data transmission apparatus further comprises a demultiplexer configured to demultiplex the single additional data and generate the plurality of additional data.

4. The data transmission apparatus of claim 1, further comprising:
a TxID (transmitter identification) generator configured to generate a TxID signal used when analyzing broadcasting channels through which the broadcasting signal is transmitted and received; and
a first power controller configured to control average power of the TxID signal,
wherein the coupler generates the broadcasting signal by coupling the main signal, the plurality of additional signals controlled in the average power thereof and the TxID signal.

5. The data transmission apparatus of claim 1,
wherein the additional data generator comprises a plurality of additional data generators configured to respectively generate the plurality of additional data,
wherein the additional signal generator comprises a plurality of additional signal generators configured to respectively generate the plurality of additional signals, in one-to-one correspondence to the plurality of additional data generators, and
wherein the power controller comprises a plurality of power controllers configured to respectively control the average power of the plurality of additional signals, in one-to-one correspondence to the plurality of additional signal generators.

6. The data transmission apparatus of claim 5, wherein the plurality of power controllers control power levels of the plurality of additional signals to a power level lower than a power level of the main signal.

7. The data transmission apparatus of claim 6, wherein a first power controller of the plurality of power controllers comprises:
a main signal calculator configured to calculate average power of the main signal;
a first additional signal calculator configured to calculate average power of a first additional signal of the plurality of additional signals;
a first additional signal determiner configured to compare the average power of the main signal and the average power of the first additional signal and determine an average power control value of the first additional signal; and
a first multiplier configured to multiply the first additional signal by the average power control value of the first additional signal and output the first additional signal controlled in the average power thereof to the coupler.

8. The data transmission apparatus of claim 7, wherein an optional N^{th} power controller, which comes after the first power controller among the plurality of power controllers, comprises:
an N^{th} additional signal calculator configured to calculate average power of an N^{th} additional signal of the plurality of additional signals;
an N^{th} additional signal determiner configured to compare the average power of the N^{th} additional signal and average power of an (N−1)^{th} additional signal controlled in the average power thereof and determine an average power control value of the N^{th} additional signal; and
an N^{th} multiplier configured to multiply the N^{th} additional signal by the average power control value of the N^{th} additional signal and output the N^{th} additional signal controlled in the average power thereof to the coupler.

9. The data transmission apparatus of claim 7, wherein an optional N^{th} power controller, which comes after the first power controller among the plurality of power controllers, comprises:
an N^{th} additional signal calculator configured to calculate average power of an N^{th} additional signal of the plurality of additional signals;
an N^{th} additional signal determiner configured to compare the average power of the main signal and the average power of the N^{th} additional signal and determine an average power control value of the N^{th} additional signal; and
an N^{th} multiplier configured to multiply the N^{th} additional signal by the average power control value of the N^{th} additional signal and output the N^{th} additional signal controlled in the average power thereof to the coupler.

10. The data transmission apparatus of claim 6, wherein the plurality of power controllers comprise:
a determiner configured to determine average power control values of the plurality of additional signals according to a preset insertion level; and
a multiplier configured to multiply the plurality of additional signals by the average power control values and output the plurality of additional signals controlled in the average power thereof to the coupler.

11. The data transmission apparatus of claim 10, wherein the determiner determines the average power control values in consideration of the average power of the main signal or the power levels of the plurality of additional signals.

12. A data reception apparatus of a communication system, comprising:
a receiver configured to receive a broadcasting signal corresponding to broadcasting services, through a broadcasting channel;
an additional signal recoverer configured to separate and recover a plurality of additional signals corresponding to various additional services of the broadcasting services, from the broadcasting signal; and
an additional data recoverer configured to recover a plurality of additional data of the various additional services through the plurality of additional signals, and provide the various additional services.

13. The data reception apparatus of claim 12,
wherein the additional signal recoverer separates an optional first additional signal among the plurality of additional signals, from the broadcasting signal, and
wherein the additional data recoverer recovers first additional data of a first additional service corresponding to the first additional signal among the various additional services, through the first additional signal, and provides the first additional service.

14. The data reception apparatus of claim 13, wherein the additional signal recoverer separates an optional second additional signal among the plurality of additional signals, from the broadcasting signal, and separates and recovers the first additional signal from the broadcasting signal by using the second additional signal.

15. The data reception apparatus of claim 13, further comprising:
a main signal recoverer configured to separate and recover a main signal corresponding to a main broadcasting service of the broadcasting services, from the broadcasting signal; and
a main data recoverer configured to recover main data of the main broadcasting service through the main signal and provide the main broadcasting service,
wherein the additional signal recoverer separates and recovers the first additional signal from the broadcasting signal by using the main signal.

16. The data reception apparatus of claim 13, further comprising:
a demultiplexer configured to demultiplex the first additional signal, recover the plurality of additional data, and provide the various additional services corresponding to the plurality of additional data.

17. The data reception apparatus of claim 12, further comprising:
a TxID (transmitter identification) generator configured to generate a TxID signal used when analyzing broadcasting channels through which the broadcasting signal is transmitted and received; and
a channel analyzer configured to analyze the broadcasting channels by using the TxID signal.

18. A data transmitting method of a communication system, comprising:
generating main data corresponding to a main broadcasting service of broadcasting services and a plurality of additional data corresponding to various additional services of the broadcasting services;
generating a main signal of the main data and a plurality of additional signals of the plurality of additional data;
controlling average power of the plurality of additional signals; and
generating a broadcasting signal by coupling the main signal and the plurality of additional signals controlled in the average power thereof and transmitting the broadcasting signal.

19. The data transmitting method of claim 18,
wherein said controlling average power controls power levels of the plurality of additional signals to power levels lower than a power level of the main signal, and
wherein said controlling average power comprises:
determining average power control values of the plurality of additional signals; and
multiplying the plurality of additional signals by the average power control values and outputting the plurality of additional signals controlled in the average power thereof.

20. A data receiving method of a communication system, comprising:
receiving a broadcasting signal corresponding to broadcasting services, through a broadcasting channel;
separating and recovering a plurality of additional signals corresponding to various additional services of the broadcasting services, from the broadcasting signal; and
recovering a plurality of additional data of the various additional services through the plurality of additional signals, and providing the various additional services.
